(19) United States
(12) Patent Application Publication
(10) Pub. No.: US 2025/0130366 A1
(43) Pub. Date: Apr. 24, 2025

(54) Waveguides and method of manufacturing waveguides

(71) Applicants: SCHOTT AG, Mainz (DE); SCHOTT North America Inc., Rye Brook, NY (US)

(72) Inventors: Andreas Koglbauer, Trebur (DE); Andrea Ravagli, Shrewsbury, MA (US); James Marro, Hanover Township, PA (US); Hubertus Russert, Jugenheim (DE); Kevin Tabor, Webster, MA (US)

(21) Appl. No.: 18/721,926

(22) PCT Filed: Dec. 21, 2022
(86) PCT No.: PCT/EP2022/087346

§ 371 Date: Jun. 20, 2024

Related U.S. Application Data
(60) Provisional application No. 63/291,986, filed on Dec. 21, 2021.

(51) Int. Cl. G02B 6/06; G02B 6/02

(52) U.S. Cl. CPC G02B 6/06; G02B 6/02042

(57) ABSTRACT

The invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein light may be transmitted through the waveguide (1) by Anderson localization, and wherein the waveguide (1) has an improved properties compared to conventional fiber optic bundles.

The invention relates to waveguides for transmitting electromagnetic waves, in particular for transmitting image information, and to methods of manufacturing waveguides, in particular imageguides.

Image guides typically comprise a plurality of individual optical fibers, each of which comprises a core and a cladding surrounding the core, the optical fibers being assembled as a bundle and arranged in cross-section in a grid with a one-to-one relationship between the light input surface and the light output surface to form a plurality of pixels. Basically, each pixel serves to transmit a brightness value or color information via the image guide.

In practice, it is often desirable to have the highest possible resolution of the image guide. In principle, a high resolution can be achieved by reducing the diameter of the individual optical waveguides. However, due to physical laws, the resolution cannot be increased arbitrarily because, as the diameters of the individual optical waveguides become smaller and smaller, an increasing proportion of the field distribution of the transmitted modes exceeds the dimensions of
the optical waveguides, in particular the cladding, which leads to increased crosstalk between adjacent optical waveguides and thus to increasing blurring.

One approach to provide image guides with higher resolution is based on the wave phenomenon of transverse Anderson localization (TAL). This takes advantage of the fact that a random distribution of refractive indices over the cross-section of the image guide with simultaneous invariance of the refractive indices along the length of the image guide leads to a limitation of the coupled light in the cross-section due to destructive interference. In practice, for example, a large number of individual optical fibers with different refractive indices can be combined to form a random fiber bundle. If a light beam is coupled into such a waveguide, it propagates along the length of the image guide with a transverse extension limited in cross-section.

On the one hand, image guides based on the principle of transversal Anderson localization allow higher resolutions; on the other hand, the random distribution of the refractive indices leads to the disadvantage that the image quality, in particular the image sharpness, of the transmitted image information is subject to local fluctuations or is difficult to control. For example, the image sharpness in certain areas of the cross-section may deviate from the image sharpness in other areas of the cross-section.

Such inhomogeneities make it difficult in practice to produce image guides with a certain quality standard. Depending on the quality criteria applied to production, a high level of rejects can occur. The above-mentioned problems become even more acute if the cross-sectional area of the image

guide is to have large dimensions. This applies in particular to faceplates, where the edge length or the diameter of the cross-section sometimes exceeds the thickness of the faceplate many times over.

A faceplate is typically understood to be a group of often relatively short (a few mm), fused optical fibers or optical structural elements whose axes are perpendicular to the disk surface (a few mm² to many cm²). Their central property is to enable image transmission, identically in strict order, i.e. 1:1, or varied according to a rule, e.g. rotated, from one plate surface to another plate surface.

Accordingly, it is an object of the invention to provide waveguides, in particular image guides, as well as methods for the production thereof, which ensure an increased homogeneity, in particular of the image sharpness, over the cross-section of the waveguides. One aspect of the task of the invention is to make the homogeneity over the cross-section more controllable, and reproducible, for example in order to avoid rejects during production and to be able to reliably guarantee quality standards.

One aspect of the task of the invention is to be able to provide waveguides, in particular image guides, with large cross-sectional areas, using Anderson localization which at the same time comply with the aforementioned conditions, in particular a defined homogeneity. This relates in particular to waveguides formed as faceplates.

Another aspect of the invention is to be able to provide waveguides, in particular image guides, using Anderson localization which have a cut-off frequency (ƒƒ_{ccccc}) greater than 170 line pairs per

millimeter (lp/mm). According to another aspect of the invention, the waveguides have an area under the MTF calculated up to the cut-off frequency (f_cut) greater than 80 lp/mm. According to another aspect of the invention, the waveguides have a relative contrast P at 114 lp/mm greater than 0.40 (i.e. 40%). According to another aspect of the invention, the waveguides have a relative contrast P at 144 lp/mm greater than 0.20 (i.e. 20%). According to another aspect, the waveguides may have a relative contrast P at 1,000 or less lp/mm greater than 0.05 (i.e. 5%). According to another aspect, the waveguides have a relative contrast P from 114 to 287 lp/mm greater than 0.05 (i.e. 5%). A further aspect of the invention is to be able to provide waveguides, in particular image guides, which have a Michelson contrast greater than 0.6. In certain embodiments, for an image of Groups 6 and 7 of a positive or negative USAF51 target described herein, the waveguides have a multi-scale structural similarity index measure (MS-SSIM) greater than 0.65 for a waveguide having a transmission length of up to 20 mm, a multi-scale structural similarity index measure (MS-SSIM) greater than 0.60 for a waveguide having a transmission length of up to 50 mm, a multi-scale structural similarity index measure (MS-SSIM) greater than
0.50 for a waveguide having a transmission length of up to 100 mm, and/or a multi-scale structural similarity index measure (MS-SSIM) greater than 0.45 for a waveguide having a transmission length of up to 1,000 mm.

To solve the problem, the present invention discloses waveguides for transmitting electromagnetic waves using Anderson localization, in particular for transmitting image information from a proximal end of the waveguide to a distal end of the waveguide, along a transport direction extending between the proximal and distal ends, and across a cross-section extending transversely to the transport direction, wherein the waveguide comprises a plurality of structural elements.

At least two different types of structural elements can be used, namely a first type having a first refractive index and a second type having a second refractive index which is different than the first refractive index. Accordingly, the plurality of structural elements may comprise at least one structural element of the first type as well as at least one structural element of the second type, or

conversely one or more structural elements of the first type as well as one structural element of the second type, or may comprise both a plurality of structural elements of the first type and a
plurality of structural elements of the second type. Of course, also more than two different types, e.g. three different types of structural elements may be used.

The structural elements can each extend along the transport direction as well as proportionally over the cross-section of the waveguide in such a way that a plurality of cross-sectional regions is defined in the cross-section of the waveguide, each corresponding to the cross-section of a single structural element. Accordingly, the structural elements can extend side by side, in particular parallel to one another, along the transport direction of the waveguide and their cross-sections can each occupy a planar portion of the cross-section of the waveguide and therefore can each

define a cross-sectional region of the cross-section of the waveguide. The cross-sectional regions can thus correspond in particular to the surface regions formed by the structural elements when looking at a cross-sectional surface of the waveguide, for example the light entry or light exitsurface.

According to some embodiments of the invention, the structural elements, in particular their cross-sectional regions, are thereby non-uniformly formed, but clearly defined by a predetermined rule. Accordingly, the structural elements can exhibit a non-uniformity in relation to one another,

i.e. can be formed non-uniformly in relation to one another, for example non-uniformly arranged, non-uniformly shaped and/or non-uniformly composed. In particular, the non-uniformity does not need to lie in the individual structural elements themselves, but can lie in the totality of the structural elements; accordingly, there can be in particular a physical disorder, i.e. a deviation from one or the symmetry. On the other hand, the unevenly formed structural elements can be formed in a fixed manner by a predetermined rule, i.e. are not formed randomly. The characteristic that the structural elements can exhibit a non-uniformity or a disorder with respect
to each other is thus opposed by a regularity, in particular in the sense that the non-uniformity or the disorder follows a defined rule and not randomness. Accordingly, in particular, the non-uniformity or the disorder can be uniquely predetermined or predetermined by a rule or is characterized or characterizable by a rule.

The non-uniformity of the structural elements, in particular of their cross-sectional regions, can be pronounced in various ways.

For example, the cross-sectional regions of the structural elements may have a non-uniform, in particular aperiodic, arrangement which is uniquely determined by the predetermined rule. For example, the cross-sectional regions may be arranged differently from a periodic grid. However, the cross-sectional regions may also be non-uniformly distributed on a periodic grid, for example.

Alternatively or additionally, the cross-sectional regions of the structural elements may have geometries which are non-uniform with respect to one another, in particular differ from one another, for example non-uniform diameters, which are clearly defined by the predetermined rule. However, the geometries of the cross-sectional regions can also be of the same type, buttwisted (e.g. inverted) relative to one another, in particular in the case of cross-sectional regions which have a non-circular shape, for non-limiting example as disclosed in U.S. Pat. No. 11,079,538, the entire contents of which are hereby incorporated by reference.

In some embodiments, each fiber has a diameter, and at least one of the fiber diameter and core-to-clad diameter ratio (if the fiber has a cladding) varies as function of a fiber's radial displacement from the central bundle axis, for non-limiting example as disclosed in U.S. Pat. No. 11,079,538, the entire contents of which are hereby incorporated by reference.

Furthermore, the structural elements may alternatively or additionally have refractive indices which are unequal to each other, in particular differ from each other, and which are uniquely determined by the predetermined rule.

In particular, due to the physical effect of transverse Anderson localization, a limitation of the amplitude of a transmitted electromagnetic wave to a partial region of the cross-section of the waveguide can be achieved by the non-uniformity of the structural elements. Accordingly, the structural elements, in particular their cross-sectional regions, can be in particular non-uniformly formed in such a way that electromagnetic waves transmitted by the waveguide remain localized in a direction extending transversely to the transport direction, in particular in order to transmit electromagnetic waves, possibly of selected wavelength ranges, in particular also visible and/or

infrared and/or ultraviolet light, in a directed or limited manner, in particular image information. In this case, image information can be transmitted with high sharpness due to the limited nature of
the propagation of light in the waveguide according to the invention, whereby the sharpness can be improved compared to conventional fiber-optic image guides.

On the other hand, the structural elements, in particular their cross-sectional regions, can be formed fixed by the predetermined rule in such a way that the waveguide has a reproducible structure, in particular in such a way that further waveguides with a structure identical to the waveguide can be produced. In other words, the non-uniformity or deviations from a symmetry inherent in the waveguide can be generated and reproduced for a further waveguide solely on the basis of the predetermined rule. The predetermined rule can thus contain, in particular, the detailed information for describing and/or constructing the waveguide in its structure formed by the plurality of structural elements, in particular cross-sectional regions.

The structure of the waveguide defined by the cross-sectional regions of the structural elements in cross-section can be invariant along the transport direction or similar in a mathematical sense. In this case, the waveguide can have regions along the transport direction whose cross-section varies, for example changes continuously from the proximal to the distal end or in at least one region in between, or changes continuously in at least one section of a length L. The length L may be at least as long as the largest extension or difference of the cross-sectional variation or corresponds at least to the largest extension of the larger input cross-section.

In the case that the waveguide is similar along the transport direction in a mathematical sense, this may or may not be accompanied by a change in cross-sectional shape. The corresponding position of one or more structural elements at the proximal and distal ends may also change in such a way that they are twisted relative to one another, which may occur, for example, by

twisting the waveguide during manufacture and/or by thermal post-treatment under the action of a rotational force or correspondingly directed force. A combination of cross-sectional change and twisting is also conceivable.

The rule of unambiguous definition, in particular of the arrangement of the cross-sectional regions, of the geometries of the cross-sectional regions and/or of the refractive indices of the structural elements, may comprise the specification of a characteristic quantity for each of the structural elements in accordance with a deterministic rule, in particular for defining the position of

the cross-sectional region, the area of the cross-sectional region or the refractive index of the respective structural element.

In other words, the predetermined rule may be a deterministic rule that uniquely and independently of randomness defines characteristics for the structural elements to describe the structure of the waveguide with its structural elements.

The rule of unambiguous specification, in particular the deterministic rule for specifying the characteristics, may comprise a sequence of fixed values, in particular a mathematical sequence of fixed values. The sequence of values can be formed as a low discrepancy series and/or as a deterministic sequence, for example as a Halton sequence, as a Sobol sequence, as a Niederreiter sequence, as a Hammersley sequence, as a Faure sequence or as a combination, combination or sequence of several sequences. For example, a part of a first sequence and a part of another sequence may also be provided in a defined manner for specifying the

characteristics.

The rule of unambiguous definition, in particular the deterministic rule for specifying the characteristic quantities, may comprise using a specific value, in particular a determinable, unambiguously specified value, of a deterministic sequence for specifying a characteristic quantity for a specific structural element, using a further value of the deterministic sequence for specifying a characteristic quantity for a further structural element, checking whether the value or the characteristic quantity for the further structural element, in particular in view of the value or the characteristic quantity for the specific structural element, violates a defined condition, and, if the defined condition is violated, discarding the further value and using a further value of the deterministic sequence to specify a characteristic quantity for the further structural element, or modifying the further value in a predefined manner, in such a way that the defined condition is fulfilled or is no longer violated. In this context, the defined condition can be in the form of a fixed minimum difference between the values or characteristic quantities, in particular in the form of a fixed minimum distance between positions of the cross-sectional areas of the structural elements.

In this context, reference is made to an exemplary description below.

In an embodiment of the waveguide, the distribution of the area contents of the Voronoi surfaces relative to the positions, in particular to the midpoints, of the cross-sectional surfaces of the structural elements of at least one type can satisfy at least one of the following conditions, which can be formed in particular as homogeneity criteria for image sharpness in an image guide.
(i) The variance V_{d} of the distribution can be smaller than the variance V_{z} of a corresponding distribution for random positions of the cross-sectional areas, the ratio V_{z}/V_{d} being between 1 and 10, in particular being greater than 1, greater than 2, greater than 2.5 and/or being less than 8, less than 7, or less than 6.5. The ratio V_{z}/V_{d} may be in a range between 1 and 8, in a range
   between 2 and 7, or in a range between 2.5 and 6.5. By variance in the sense of this application is to be understood in particular a variance normalized to the cross-sectional area A of the waveguide, such that V=σ/A² applies, where a denotes the variance of the distribution of the area contents of the Voronoi surfaces to the positions of the cross-sectional areas of the structural elements within a surface A.
(ii) the variance V_{d} of the distribution can be less than 0.38/N^{2,033}, where N denotes the number of structural elements of the at least one type, the variance again being understood in particular as a normalized variance.
(iii) The variance V_{d} of the distribution can be greater than the variance of a corresponding distribution for periodic positions of the cross-sectional areas, the variance V_{d}/A² being greater than 0, in particular greater than 10⁻¹⁰, greater than 10⁻⁹, or greater than 10⁻⁸, the variance again being in particular to be understood as a normalized variance.
(iv) The amount of skewness S_{d} of the distribution can be smaller than the amount of skewness S_{z} of a corresponding distribution for random positions of the cross-sectional areas, wherein the amount of skewness S_{d} is in the range between 0 and 1.5, in particular is larger than 0.01, is larger than 0.05, is larger than 0.1 and/or is smaller than 1.4, is smaller than 1.2, or is smaller than 0.8. Alternatively or additionally, the ratio of the amounts S_{z}/S_{d} may also be between 1 and
   50, in particular be greater than 1.1, greater than 1.3, greater than 1.9 and/or less than 25, less than 15, or less than 10.
(v) The kurtosis W_{d} of the distribution can be smaller than the kurtosis W_{z} of a corresponding distribution for random positions of the cross-sectional areas, wherein the kurtosis W_{d} is between 0 and 10, in particular is larger than 0.5, is larger than 1, is larger than 2 and/or is smaller than 10, is smaller than 6, is smaller than 5. Alternatively or additionally, the ratio W_{z}/W_{d} may also be
   between 1 and 5, in particular be greater than 1.1, greater than 1.5, greater than 2 and/or be less than 4.5, less than 4, or less than 3.

The ratio of the total area of the cross-sectional regions of the structural elements of the first type and the total area of the cross-sectional regions of the structural elements of the second type can be, for example, in a range between 1:9 and 9:1, in a range between 3:7 and 7:3, in a range between 4:6 and 6:4, in particular also at 5:5. This can also be understood as a degree of filling.

In particular, in the case where a plurality of structural elements is provided in the form of filamentary channels, the ratio of the total area of the cross-sectional regions of the structural

elements of the first type and the total area of the cross-sectional regions of the structural elements of the second type may also be in a range between 1:150 and 150:1, in a range between 1:100 and 100:1, or in a range between 1:50 and 50:1.

The total area of the cross-sectional regions of the structural elements for each type can be, for example, at least 1/(10*T), at least 1/(5*T) or at least 1/(3*T) of the cross-sectional area, where T denotes the number of types of structural elements.

The first refractive index of the structural elements of the first type and the second refractive index of the structural elements of the second type may differ by at least 10⁻⁴, for example by at least

10⁻³, for example by at least 10⁻², for example by at least 10⁻¹, for example by at least 1, for example by at least 2, for example by at least 3, for example by at least 4.

With respect to the lateral extent of the structural elements, it may be provided that at least one cross-sectional region has a diameter of 100 nm to 50 μm, 400 nm to 20 μm, or 1 μm to 16 μm.

Furthermore, it can be provided that at least one cross-sectional region has a diameter which lies between 0.1 times and 10 times the average wavelength, in particular of a wavelength range of electromagnetic waves to be preferably transmitted, between 0.2 times and 5 times the average wavelength, or between 0.5 times and 2 times the average wavelength.

With respect to the geometric shape of the structural elements, it may be provided that a cross-sectional region has a non-circular or polygonal geometry, for example pentagonal or hexagonal.

As described above, the waveguide may comprise a plurality of structural elements, wherein at least two different types of structural elements are comprised. In one embodiment of the waveguide, it may now be provided that one structural element of the first type and a plurality of structural elements of the second type are comprised. Accordingly, the plurality of structural elements comprises in particular exactly one structural element of the first type.

The structural element of the first type can be in particular formed as a, for example monolithic, base body with or from a first medium, wherein the first medium has the first refractive index. The structural elements of the second type may be formed as cavities in the base body, wherein the cavities preferably form the second refractive index, for example by the refractive index of air or a gas which may be present as a medium in the cavities.

The cavities in the base body can be formed as filamentary channels, i.e. channels which, for example, have a significantly smaller area compared to the cross-sectional area of the waveguide, which can be introduced into the base body in particular with a laser beam of an ultrashort pulse laser. Furthermore, the filamentary channels in the base body can be reworked, in particular chemically or physically by etching processes, e.g. in order to smooth the contours of the filamentary channels.

In particular in the case that the waveguide is formed as a base body with cavities, but also independently thereof, the waveguide may have a larger extension in cross-section than along the transport direction. In particular, the waveguide may be formed as a faceplate.

It may be provided that the waveguide has a cross-sectional area of at least 4 square millimeters, of at least 2,500 square millimeters, or of at least 10,000 square millimeters.

The waveguide may have in cross-section, for example, an extension which is at least 2 times greater than the extension along the transport direction, at least 5 times greater than the extension along the transport direction, or at least 10 times greater than the extension along the transport direction.

A base body with cavities can be produced or manufactured in various ways. On the one hand, the cavities in the base body can be formed by additive construction of the base body, for example by means of 3D printing processes. Alternatively or additionally, cavities may be subtractively introduced into the base body, in particular as bores which are introduced into the base body in particular by abrasive material processing methods, for example mechanical drilling. Depending on the method used, bores are not exclusively limited to round geometries.

The waveguide may be manufactured in a multi-train process, in particular such that the waveguide comprises, in addition to the plurality of structural elements, at least a second plurality

of structural elements, wherein the waveguide has, in cross-section, at least two surface regions which each comprise the cross-sectional regions of one of the two pluralities of structural elements and these may have an identical structure apart from a rotation and/or a reflection.

With regard to the size of the waveguide along the transport direction, it may be provided that the waveguide has an extension along the transport direction of less than 10 millimeters, of less than 6 millimeters, or of less than 5 millimeters, especially if the waveguide is formed as a faceplate.

In general, however, it may also be provided that the waveguide has an extension along the transport direction of at least 10 millimeters, of at least 20 millimeters, of at least 50 millimeters, or

of at least 100 millimeters.

In the case that the waveguide is formed as a base body with cavities, the cavities in the base body, in particular the filamentary channels and/or the bores, may be filled with a second medium, the second medium having the second refractive index.

With regard to the materials, it may be provided that at least one structural element, in particular the or a structural element of the first type, in particular the structural element formed as a base body, comprises or consists of one or more of the following materials as a medium: glass, quartz glass, polymer, crystals, monocrystals, polycrystalline materials and/or glass ceramic.

Furthermore, at least one structural element, in particular the or a structural element of the first type, in particular the structural element formed as a base body, may comprise or consist of a material as a medium which, in the wavelength range to be transmitted, esp. from 2 μm to 20 μm, in particular an attenuation of less than 100 dB/m, in particular of less than 50 dB/m, in particular of less than 10 dB/m, in particular of less than 1 dB/m, in particular an infrared-transmissive material, in particular a chalcogenide, in particular comprising at least one element

from the group comprising oxygen, sulphur, selenium and tellurium, and at least one element from the group comprising arsenic, germanium, phosphorus, antimony, lead, boron, aluminium, gallium, indium, titanium, sodium.

Furthermore, optically active materials may be provided, e.g. as part of a medium or a filling and/or also as a layer or coating or other modification on or on the surfaces of an assembly of structural elements formed as rods or tubes. Thus, for example, a modification of the guided electromagnetic, e.g. in the sense of an amplification or conversion, can be achieved.

A further structural element, in particular the or a structural element of the second type, may comprises or consists of another of said materials. In other words, a structural element, in particular the or a structural element of the second type, in particular therefore also the cavities in the base body filled with a second medium, may also comprise or consist of one or more of the aforementioned materials as a medium, in particular such materials which the aforementioned structural element, in particular therefore the structural element of the first type, does not comprise.

As previously described, the waveguide may comprise a plurality of structural elements that are at least two different types of structural elements are used, wherein as previously described, for example, one structural element of the first type and many structural elements of the second type

may be used.

In a further embodiment, it is now provided that a plurality of structural elements of the first type and a plurality of structural elements of the second type can be used.

The structural elements of the first type may be formed as, in particular, rod-shaped or tubular bodies with or made of a first medium, the first medium having the first refractive index.

The structural elements of the second type can be formed as, in particular, rod-shaped or tubular bodies with or from a second medium, the second medium having the second refractive index, and/or as cavities in the structural elements of the first type, the cavities forming the second refractive index or being filled with a second medium having the second refractive index.

In particular, in the case where the structural elements of the second type can be present as filled cavities in the structural elements of the first type, the structural elements may be formed as core-shell systems such that the core corresponds to the filled cavity.

In this context, rod-shaped or tubular bodies are not to be understood exclusively as those with a round cross-sectional geometry.

The invention further relates to a waveguide, in particular having one or more of the features described herein, for transmitting electromagnetic waves, in particular for transmitting image information from a proximal end of the waveguide to a distal end of the waveguide, along a transport direction extending between the proximal and distal ends, and over a cross-section extending transversely to the transport direction, wherein the waveguide comprises a plurality of structural elements, wherein at least two different types of structural elements are comprised, namely a first type having a first refractive index and a second type having a second refractive index, wherein the structural elements each extend along the transport direction as well as proportionally across the cross-section of the waveguide, such that in the cross-section of the waveguide a plurality of cross-sectional regions is defined, each corresponding to the cross-section of a single structural element, and wherein the waveguide has a greater extension in the

cross-section than along the transport direction.

The invention further relates to a waveguide, in particular having one or more of the features described herein, for transmitting electromagnetic waves, in particular for transmitting image information from a proximal end of the waveguide to a distal end of the waveguide, along a transport direction extending between the proximal and distal ends, and over a cross-section extending transversely to the transport direction, wherein the waveguide comprises a plurality of structural elements, wherein at least two different types of structural elements are included, namely a first type with a first refractive index and a second type with a second refractive index, wherein the structural elements each extend along the transport direction as well as proportionally over the cross-section of the waveguide, such that a plurality of cross-sectional regions is defined in the cross-section of the waveguide which each correspond to the cross-section of a single structural element, and wherein at least one of the structural elements in the wavelength range from 2 μm to 20 μm has an attenuation of below 100 dB/m, in particular of below 50 dB/m, in particular of below 10 dB/m, in particular of below 1 dB/m, in particular comprises or consists of an infrared-transmissive material.

Depending on the extension of the waveguide in the transport direction, the following attenuations can also be provided. For a waveguide with an extension in the transport direction of at least 5 millimeters, an attenuation of less than 100 dB/m can be provided. For a waveguide with an extension in the transport direction of at least 10 centimeters, an attenuation of less than 50 dB/m

may be provided. For a waveguide with an extension in the transport direction of at least 1 meter, an attenuation of less than 30 dB/m can be provided.

The invention further relates to a method for producing a waveguide, in particular a waveguide having one or more of the features described herein, comprising providing a structural element of

a first type having a first refractive index, in the form of a, in particular monolithic, base body with or from a first medium, and introducing a plurality of structural elements of a second type having a second refractive index, cavities being introduced into the base body for this purpose and these cavities being filled with a second medium.

The structural elements of the second type can be introduced in such a way that they each can extend proportionally over the cross-section of the waveguide in such a way that a plurality of

cross-sectional regions are defined in the cross-section of the waveguide, each corresponding to the cross-section of a single structural element of the second type.

According to the invention, the structural elements of the second type can be further introduced in such a way that the cross-sectional regions of the structural elements of the second type have a non-uniform arrangement, in particular aperiodic, but clearly defined by a predetermined rule, and/or have non-uniform geometries, for example diameters, but clearly defined by a predetermined rule.

In the method of manufacturing a waveguide, it may be provided that the rule of univocal definition, in particular of the arrangement and/or of the geometries of the cross-sectional regions, comprises specifying a characteristic quantity for each of the structural elements of the second type according to a deterministic rule, in particular for defining the position and/or the area of the cross-sectional region of the respective structural element.

The rule of unambiguous specification, in particular the deterministic rule for specifying the characteristics, may in particular involve the use of a sequence of fixed values, in particular a mathematical sequence. Further, reference is made to the sequences indicated above. Furthermore, reference is made to the steps of drawing on, checking, and, if necessary, discarding/modifying values given in detail above.

The distribution of the surface areas of the Voronoi surfaces to the positions, in particular to the centers, of the cross-sectional surfaces of the structural elements of at least one type may satisfy at least one of the above conditions, in particular (i), (ii), (iii), (iv), (v).

In the process for producing a waveguide, the cavities can be introduced into the base body as filamentary channels, in particular with a laser beam, for example an ultrashort pulse laser. Furthermore, the filamentary channels in the base body can be post-processed, in particular chemically and/or physically by etching processes, for example to smooth the contours of the filamentary channels, in particular before the filamentary channels are filled with a second medium.

The cavities may be introduced into the base body at a distance from each other which is greater than the diameter of the cavities, for example two times greater than the diameter of the cavities or three times greater than the diameter of the cavities.

The cavities can also be produced by additive construction of the base body and/or subtractively introduced into the base body, in particular by abrasive material processing methods, e.g. mechanical drilling.

With regard to the materials, it may be provided that the main body comprises or consists of, as a medium, one or more of the materials listed above. Furthermore, at least one structural element of the second type may comprise or consist of, as a medium, one or more of the materials mentioned for the main body of the first type, in particular those which the main body does not comprise.

The invention further relates to methods of manufacturing waveguides, in particular comprising one or more of the herein-mentioned method steps, which may be referred to as a tensile method or a multi-tensile method.

In these methods, a waveguide having one or more of the above features can be assembled with one or more further waveguides, each also having one or more of the above features, in such a way that the waveguides have transport directions parallel to each other to form a preform.

The assembled waveguides can be then drawn together in length along the transport direction. In particular, a drawing factor of at least 1:2, of at least 1:10, or of at least 1:100 is considered.

The lengthwise assembled waveguides may then be disassembled into sections transverse to the direction of transport and the sections may in turn be assembled with the directions of transport parallel to each other to again form a preform.

The assembled sections can then in turn be drawn together in length along the transport direction. Here, again, a drawing factor of at least 1:2, of at least 1:10, or of at least 1:100, comes into consideration.

The waveguides and/or the sections may each be assembled to form a preform such that the arrangement of the assembly is uniquely determined by a predetermined rule, in particular in accordance with the details set out above.

The waveguides and/or the sections can further each be assembled to form a preform in such a way that the structure formed by the cross-sectional regions of the second structural elements in cross-section are rotated in relation to one another, in particular in a predefined manner, and in particular are not rotated in relation to one another. Furthermore, the waveguides and/or the sections can be turned lengthwise during assembly, so that a mirror image of the cross-section is formed.

In this context, sections may also be assembled which are made from at least one further preform. These preforms are may be assembled according to a common determining rule and are

substantially identical, but may also follow different determining rules.

In addition, the waveguides and/or the sections may each be assembled in an automated manner, in particular robotically. Further, the elongated assembled waveguides and/or the elongated assembled sections may be fused by application of heat and/or pressure, and in particular under vacuum.

The invention further relates to methods of manufacturing waveguides, wherein two or more waveguides are manufactured which are formed in the same way, such that the cross-sectional regions of the structural elements of the second type each have the same non-uniform, but uniquely defined by a predetermined rule, arrangement and/or have the same non-uniform, but uniquely defined by a predetermined rule, geometries, for example diameters.

In particular, the method can be designed as a method for producing a plurality of identical waveguides, the plurality of waveguides may be produced independently of one another. In particular, further waveguides with the same structure can thus be manufactured solely on the basis of the predefined rule.

Apart from the fact that the method can be used to produce a plurality of identical waveguides, the method is also suitable for producing a plurality of waveguides which match at least with respect to certain properties. For example, the plurality of waveguides may satisfy a defined homogeneity criterion for image sharpness and/or satisfy one or more of the conditions described

above concerning the distribution of the area contents of the Voronoi surfaces to the positions, in particular to the centers, of the cross-sectional areas of the structural elements of at least one type.

The invention further relates to waveguides, in particular having one or more of the features mentioned above for the waveguide, which is manufactured or manufacturable by a process comprising one or more of the process steps described above.

Finally, the invention also relates to sets comprising two or more waveguides, each in particular having one or more of the features mentioned above for the waveguide, in particular produced or producible by means of a method comprising one or more of the method steps described above, wherein the waveguides each comprise a plurality of structural elements, wherein the structural elements, in particular their cross-sectional regions, are formed non-uniformly but unambiguously by a predetermined rule, and wherein the two or more waveguides are formed identically such that the structural elements, in particular their cross-sectional regions, are formed non-uniformly

in the same manner.

In the following embodiments of the invention are described with reference to the Figures described. They show:

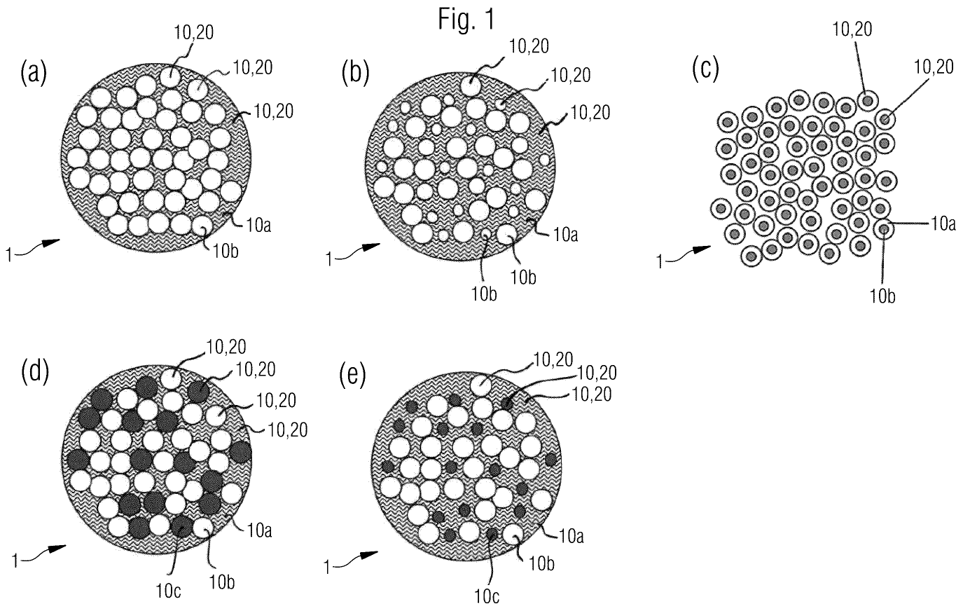

FIG. 1: Schematic illustration of cross-sections of various waveguides having (a), (b), (c) two types of structural elements and (d), (e) three types of structural elements, respectively, wherein the cross-sectional areas of the structural elements are arranged unevenly,

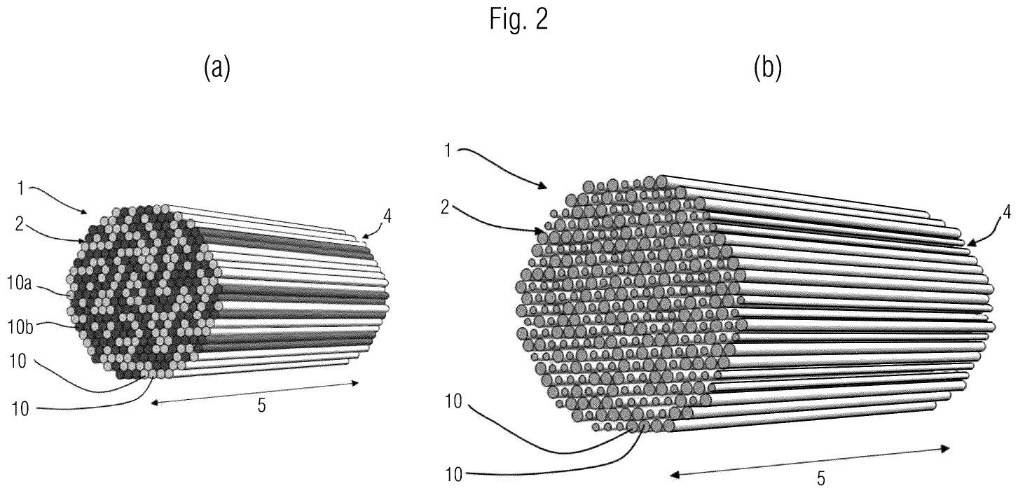

FIG. 2: Schematic perspective views of two waveguides having (a) two types of structural elements whose cross-sectional areas are non-uniformly distributed on a grating and (b) a plurality of structural elements of non-uniform refractive indices (plurality of types) and/or non-uniform geometries (diameters),

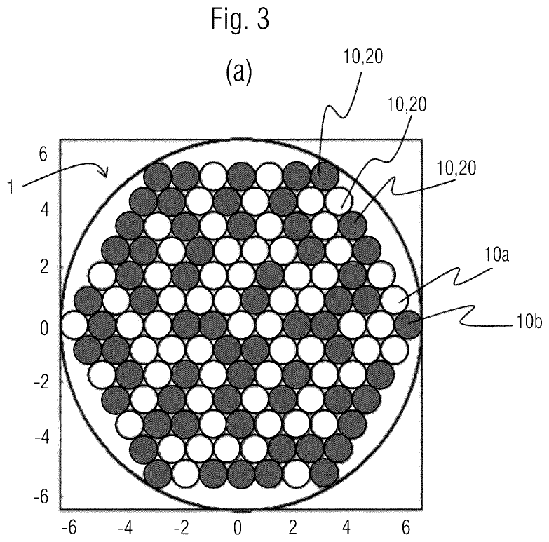

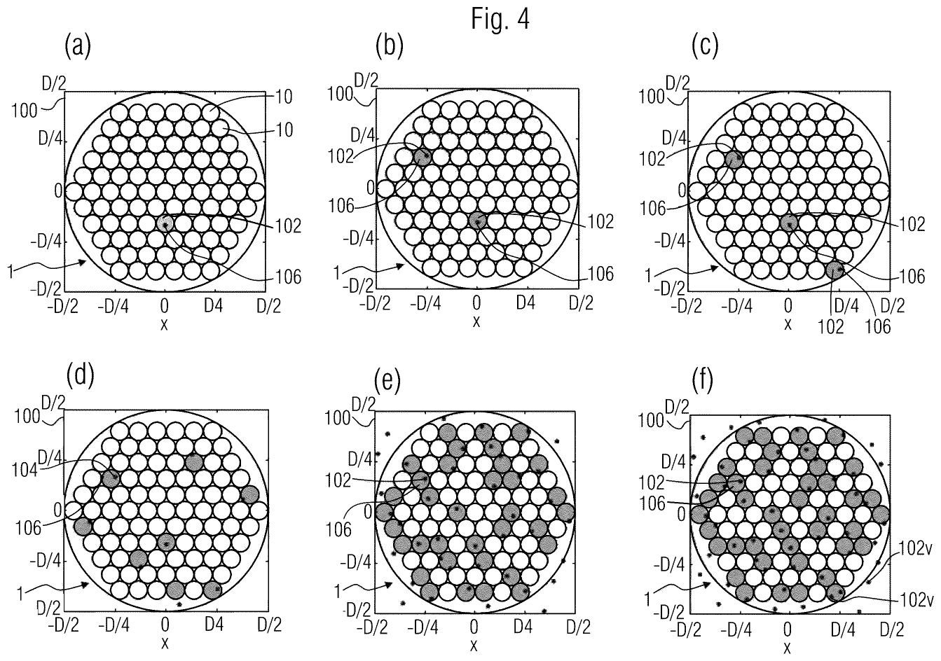

FIG. 3: Schematic cross-section of a waveguide with two types of structural elements whose cross-sectional areas are unevenly distributed on a hexagonal lattice,

FIG. 4: Schematic cross-sections of a waveguide with two types of structural elements, where the types/refractive indices of the structural elements are/will be determined according to a deterministic rule,

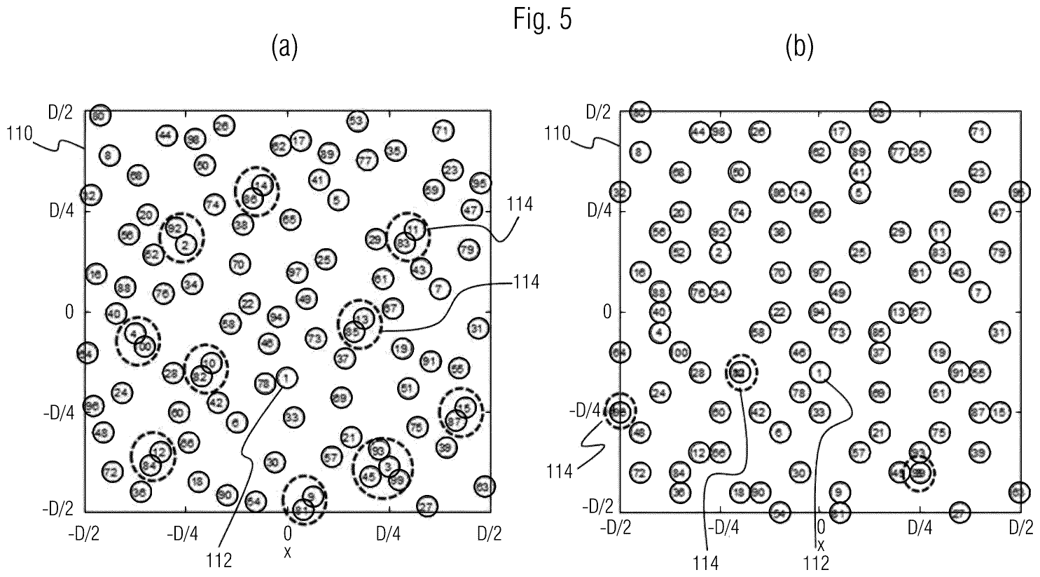

FIG. 5: Schematic cross-sections of a waveguide, e.g. in the form of a faceplate, having a structural element of a first type as a base body and a plurality of structural elements of a second type as cavities in the base body, the positions of the structural elements of the second type within the base body being fixed in accordance with a deterministic rule,

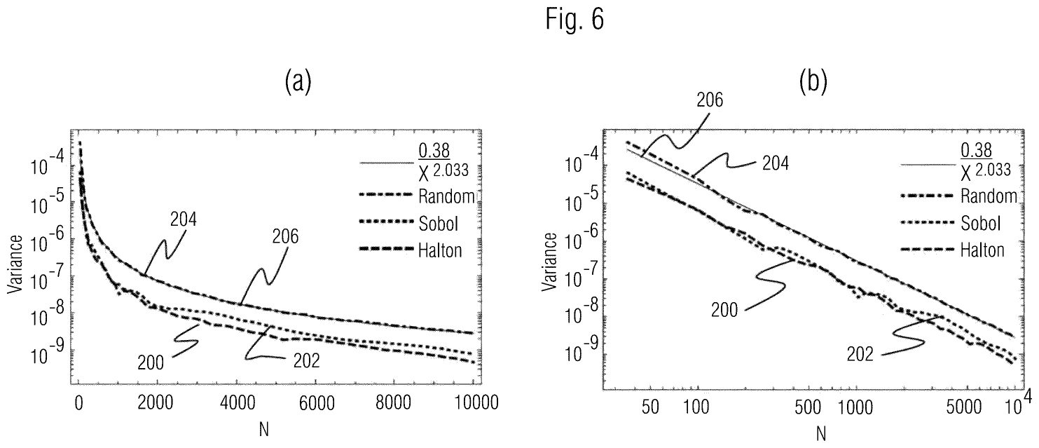

FIG. 6: Plots of the variance of the distribution of the area contents of the Voronoi surfaces to the positions of the cross-sectional areas of the structural elements of a second type positioned within a structural element of a first type, plotted against the number of structural elements of the second type, in (a) logarithmic and (b) double logarithmic representation,

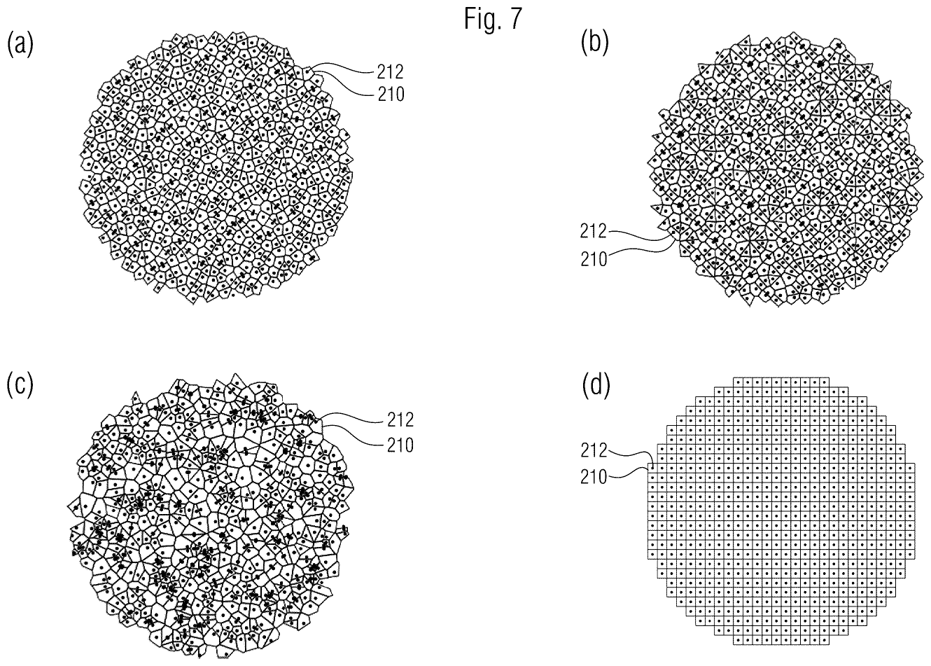

FIG. 7: (a) examples of Voronoi surfaces to the positions of the cross-sectional surfaces of the structural elements of a second type according to a Halton sequence positioned within a structural element of a first type having a round cross-section, (b) positioning according to a Sobol sequence, (c) random positioning, (d) periodic positioning as further comparative examples,

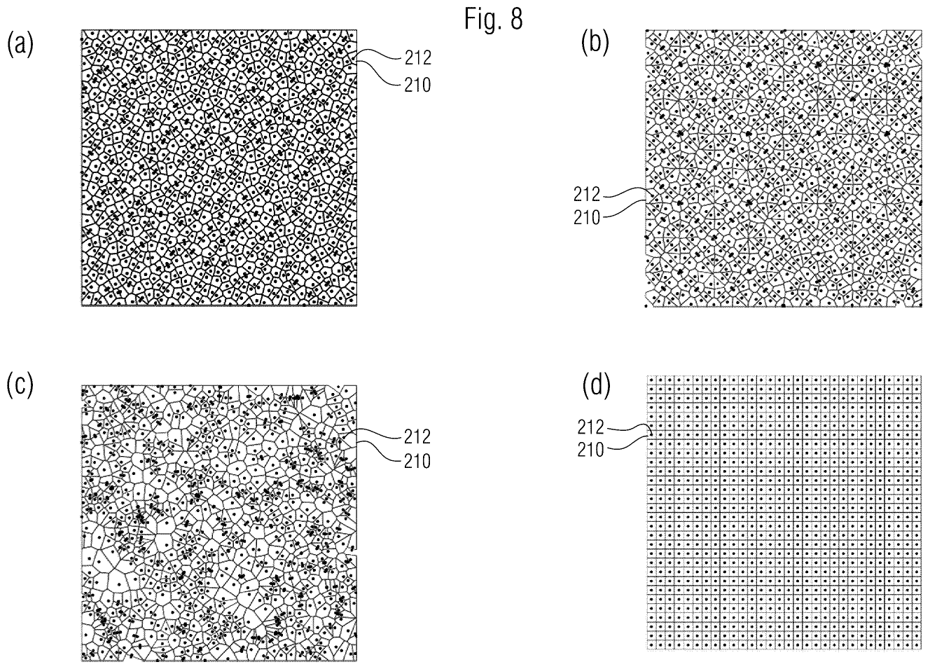

FIG. 8: (a) Examples of Voronoi surfaces to the positions of the cross-sectional surfaces of the structural elements of a second type positioned within a structural element of a first type having a square cross-section, (b) positioning according to a Sobol sequence, (c) random positioning, (d) periodic positioning as further comparative examples,

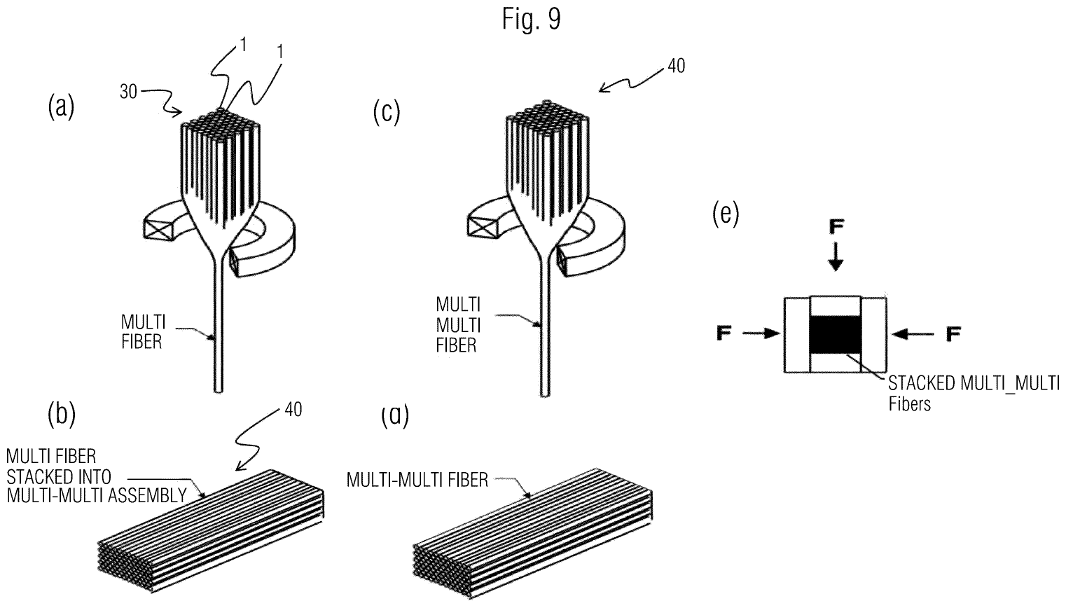

FIG. 9: Schematic perspective views of (a) waveguides assembled into a preform, which are drawn into length, (b), (c) waveguides assembled therefrom again into a preform, which are drawn into length, and (d) assembled again, and (e) waveguides fused underpressure,

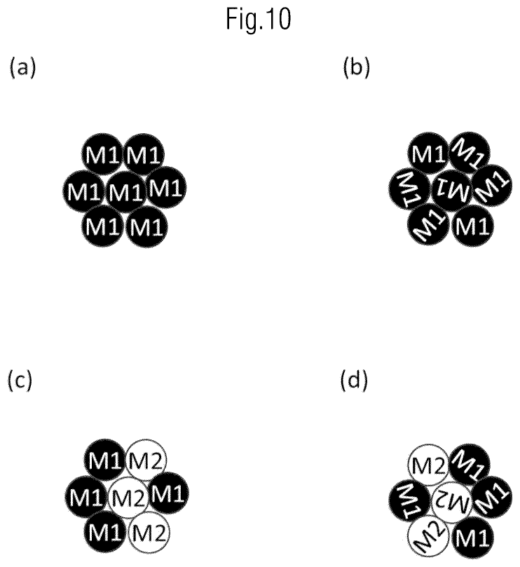

FIG. 10: Schematic cross-sections of the waveguides assembled in FIG. 9, again to form a preform, (a), (b) as sections from one waveguide drawn to length, (c), (d) as sections from two waveguides drawn to length, the waveguides (a), (c) being untwisted relative to one another, (b), (d) being twisted relative to one another in a predefined manner,

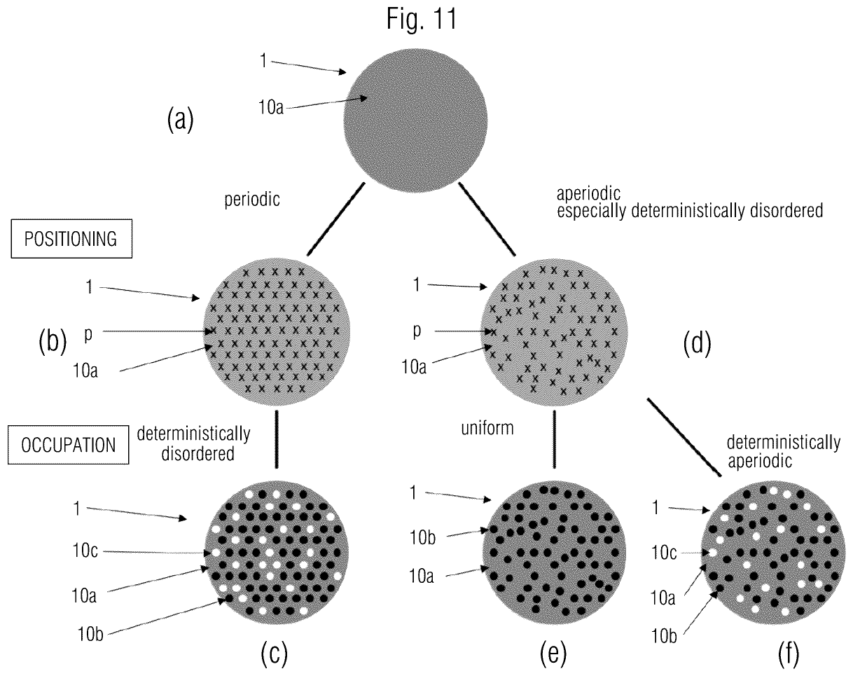

FIG. 11: Schematic illustration of various possibilities for waveguides with structural elements or their cross-sectional regions formed unevenly, but clearly defined by a predetermined rule,

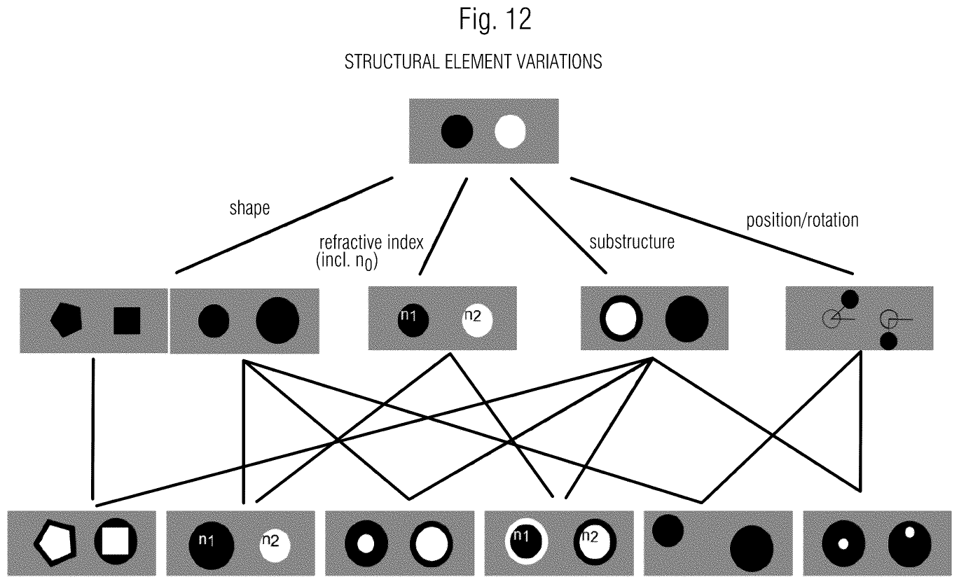

FIG. 12: schematic illustration of various aspects for variations among structural elements or their cross-sectional regions and possibilities for combinations of these aspects,

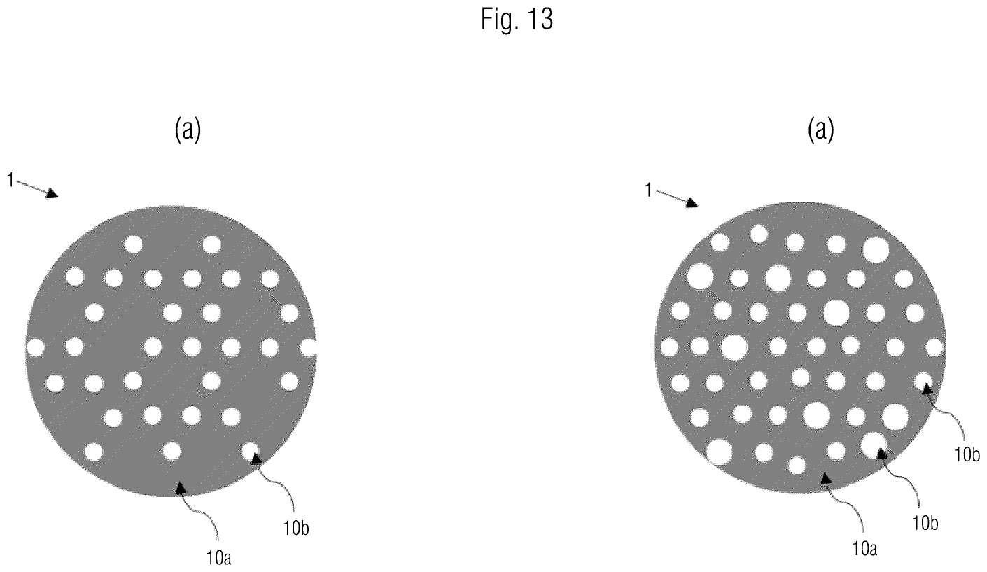

FIG. 13: Schematic illustration of various further possibilities for waveguides having structural elements, or cross-sectional regions thereof, formed unevenly but unambiguously by a predetermined rule, the waveguides each comprising a structural element of a first type and a plurality of structural elements of a second type,

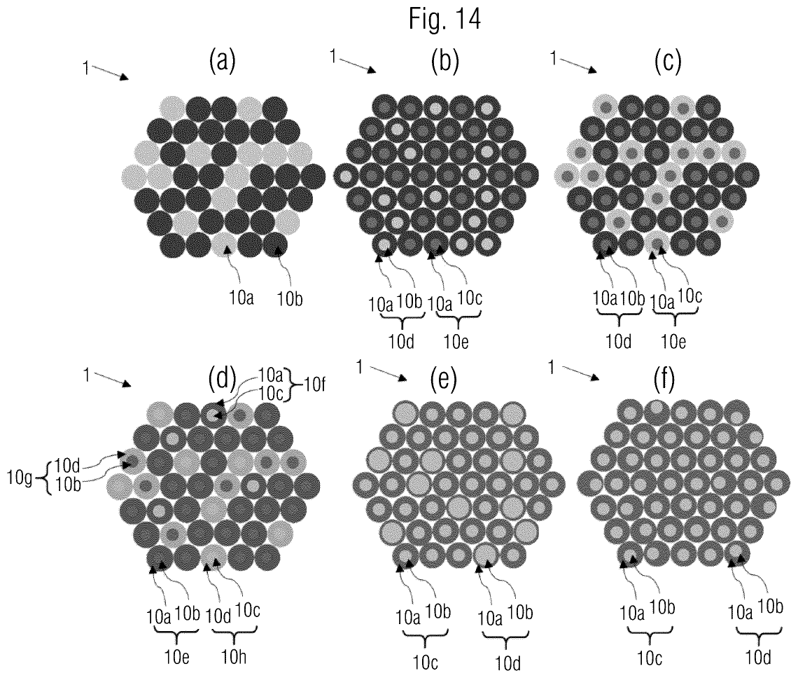

FIG. 14: Schematic illustration of various further possibilities for waveguides having structural elements or cross-sectional regions thereof which are formed unevenly but are unambiguously determined by a predetermined rule, the waveguides each comprising a plurality of structural elements of a first type and a plurality of structural elements of a second type and, if appropriate, further types

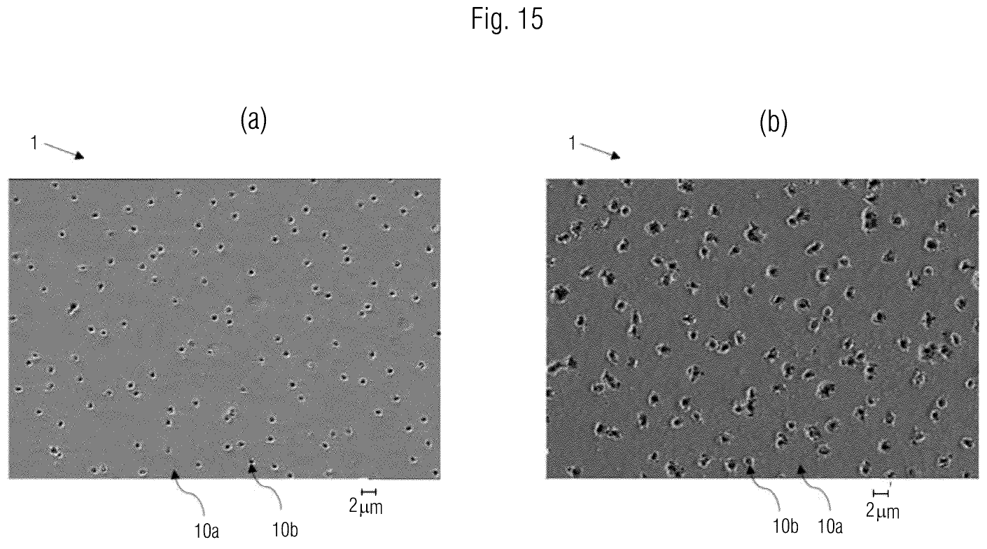

FIG. 15: Photographs of the face of manufactured waveguides having a structural element of a first type formed and a plurality of structural elements of a second type formed as filamentary channels in the structural element of the first type,

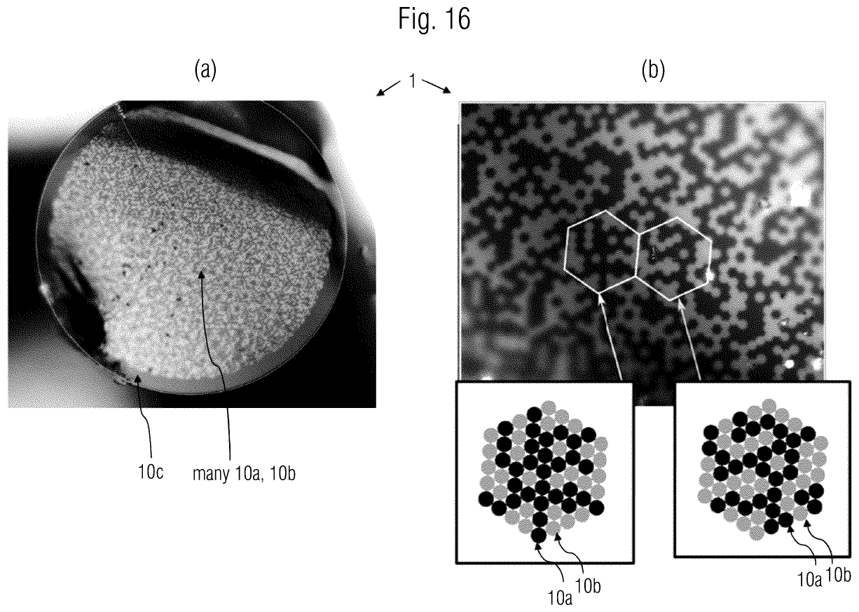

FIG. 16: a photograph (and various enlarged sections) of a manufactured waveguide having a plurality of structural elements of a first type and a plurality of structural elements of a second type,

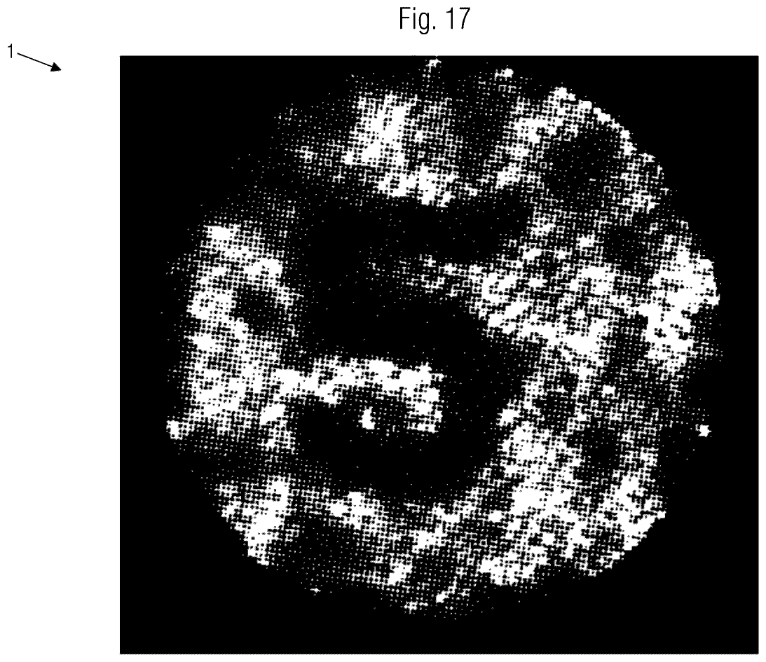

FIG. 17: a photograph of the waveguide of FIG. 16 in its application as an image guide.

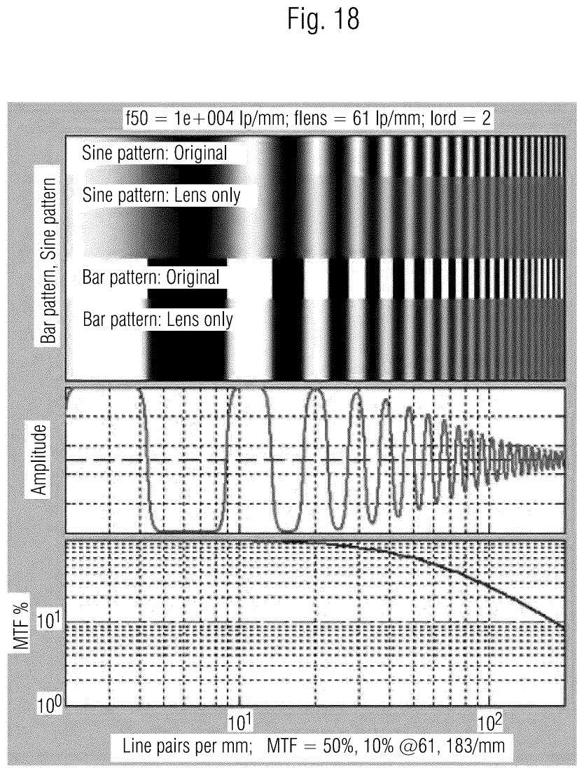

FIG. 18: a sample MTF diagram.

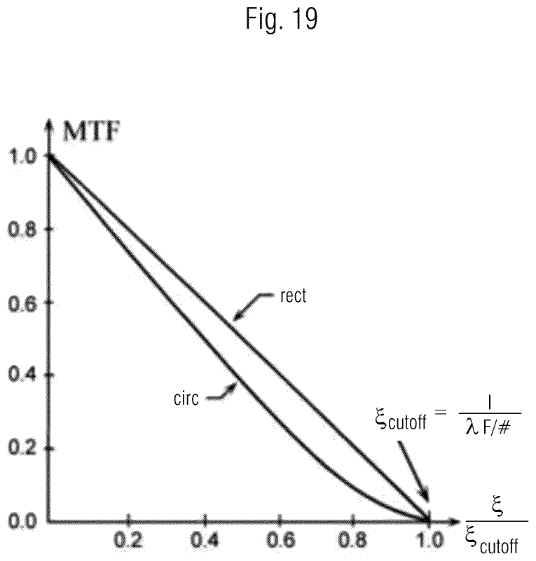

FIG. 19: a diffraction limited MTF.

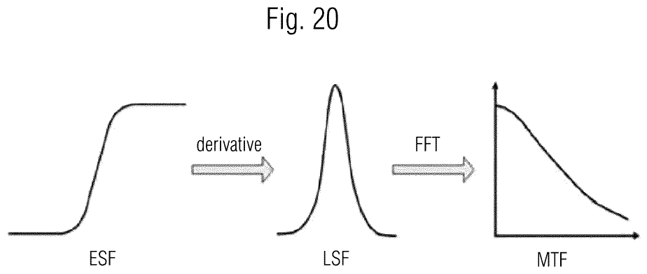

FIG. 20: The derivative of the measured edge spread function (ESF), is the line spread function (LSF), which must be Fourier transformed to receive the MTF.

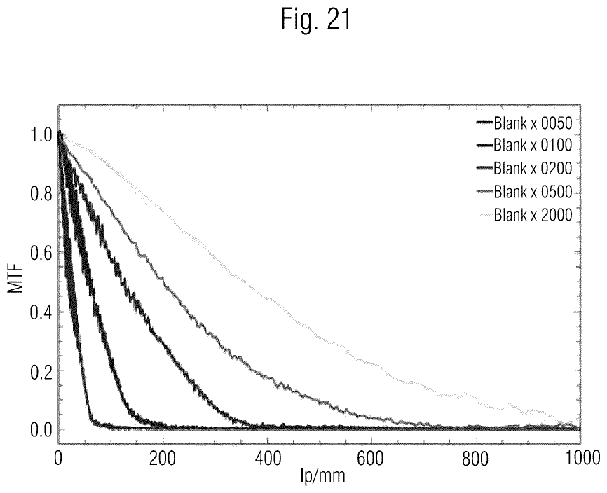

FIG. 21: Graph showing that the cutoff frequency shifts to higher values, with increasing magnification, hence decreasing effective pixel size.

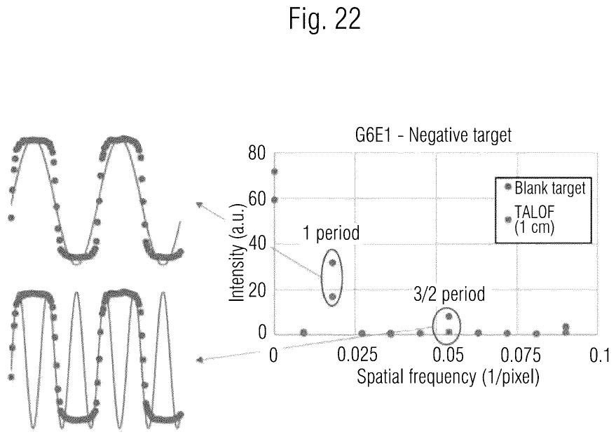

FIG. 22: Graph of spatial frequency vs. intensity.

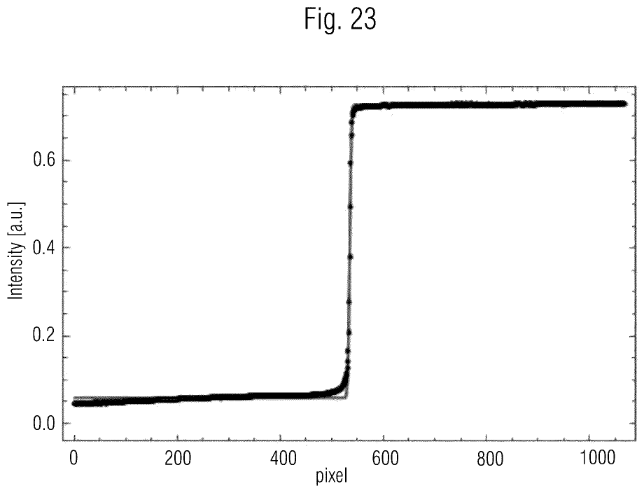

FIG. 23: Error function curve progression.

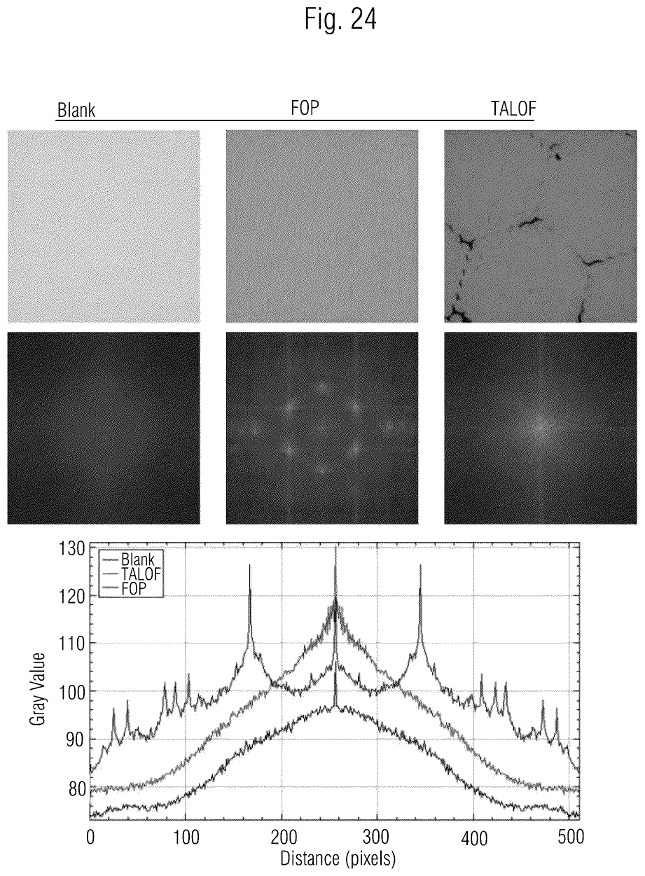

FIG. 24: Graph showing the discrete Fourier transformation data from Example 8.

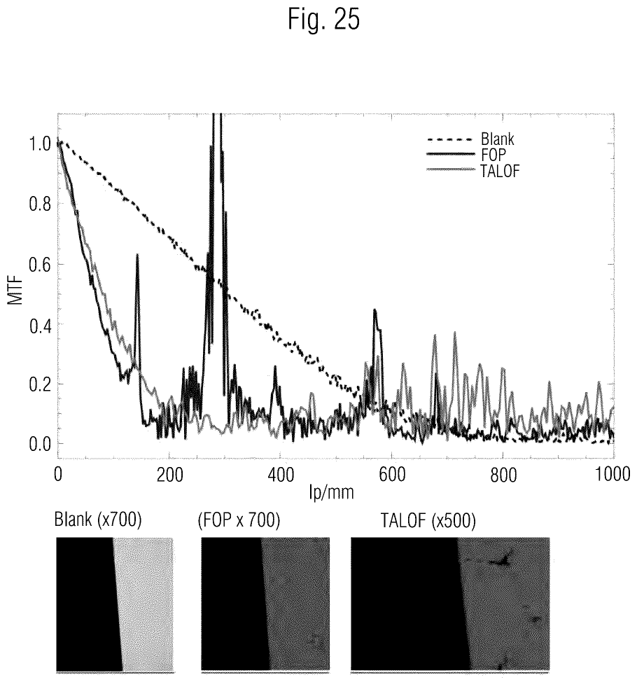

FIG. 25: Graph showing the MTF from Example 1.

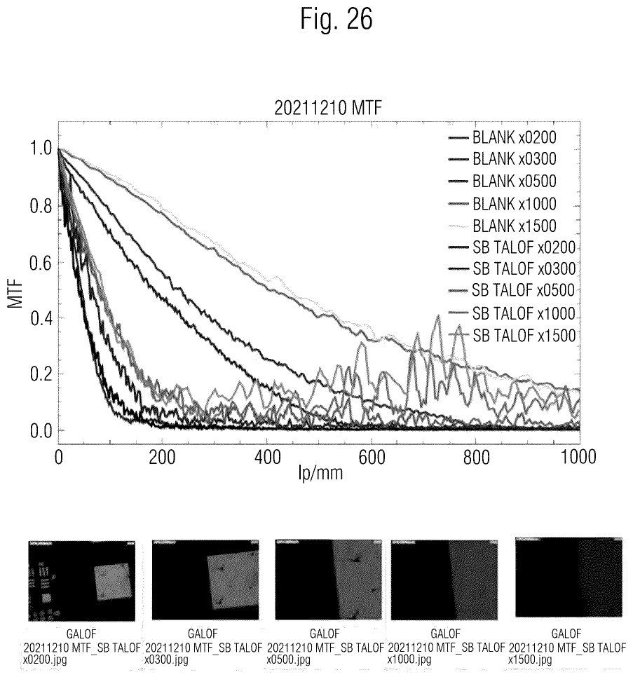

FIG. 26: Graph showing the MTF data from Example 2.

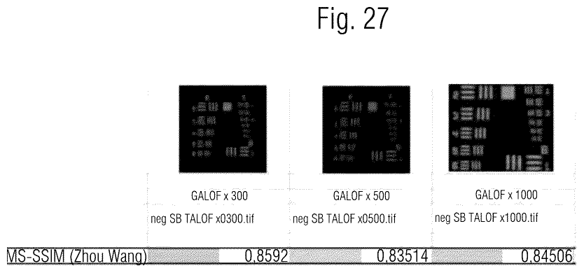

FIG. 27: Graph showing the MS-SSIM data from Example 3.

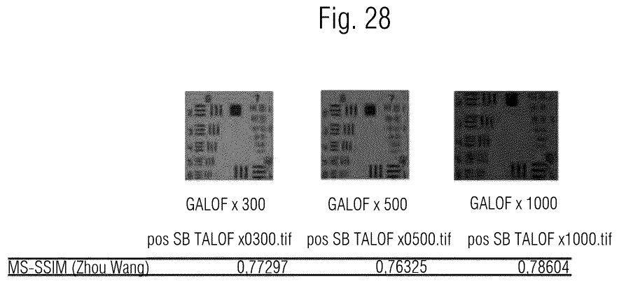

FIG. 28: Graph showing the MS-SSIM data from Example 4.

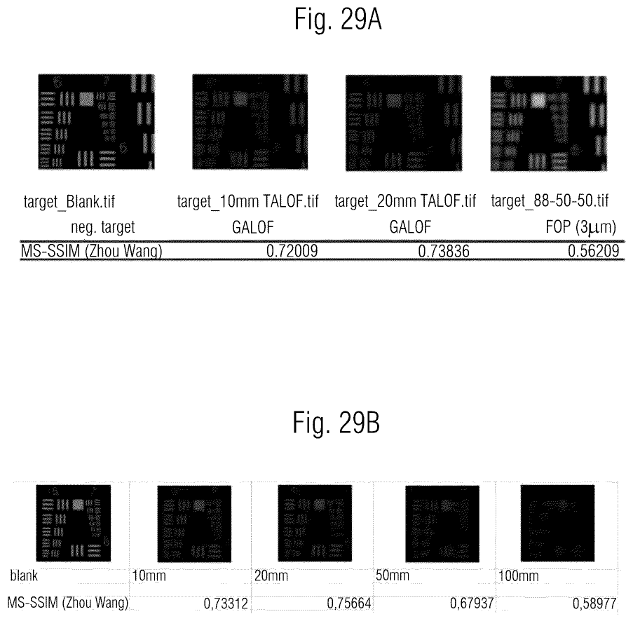

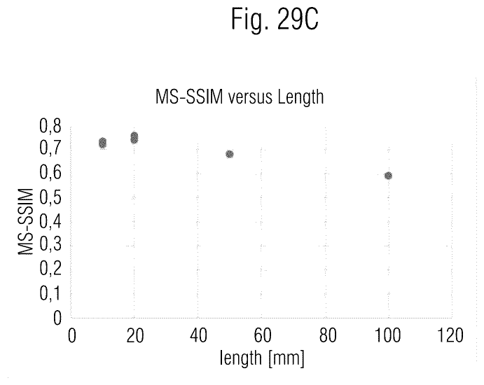

FIG. 29A: Graph showing the MS-SSIM data from Example 5.

FIG. 29B: Graph showing the MS-SSIM data from Example 5.

FIG. 29C: Graph showing the MS-SSIM data from Example 5.

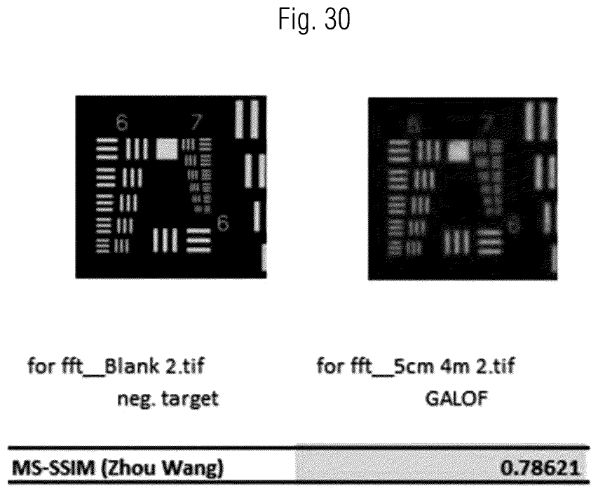

FIG. 30: Graph showing the MS-SSIM data from Example 6.

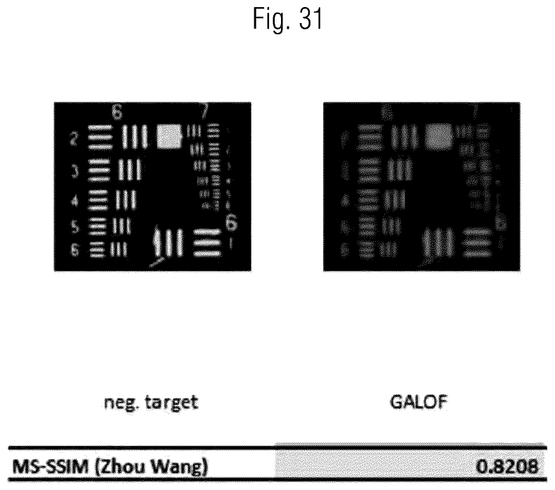

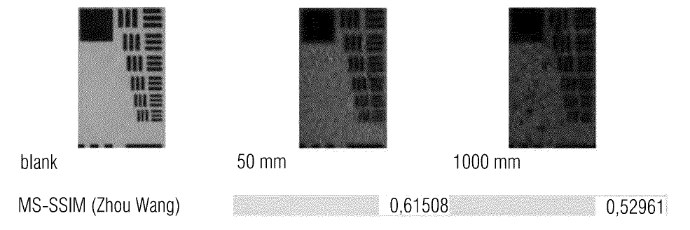

FIG. 31: Graph showing the MS-SSIM data from Example 7.

FIG. 32: Graph showing the MS-SSIM data from Example 10.

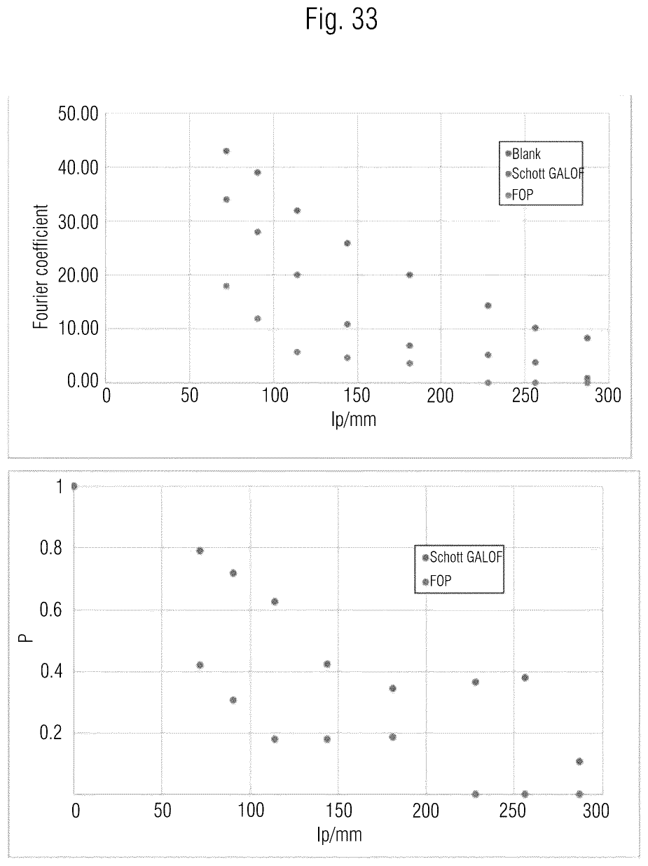

FIG. 33: Graph showing the Fourier coefficients and relative contrast P from Example 9.

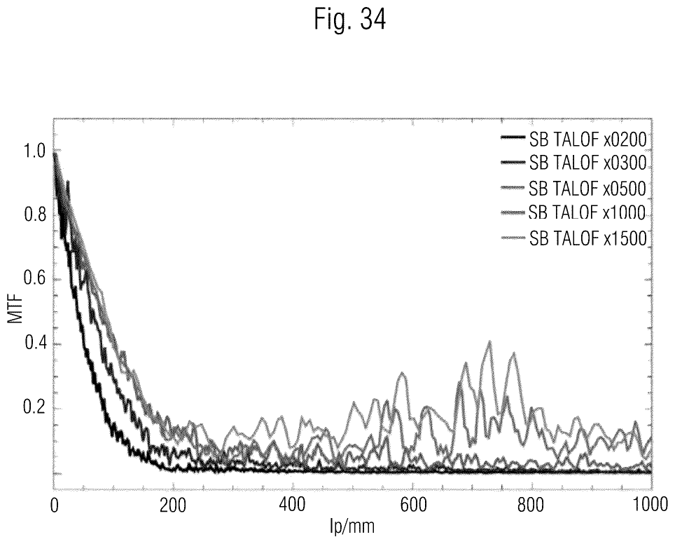

FIG. 34: MTF's calculated at different magnifications.

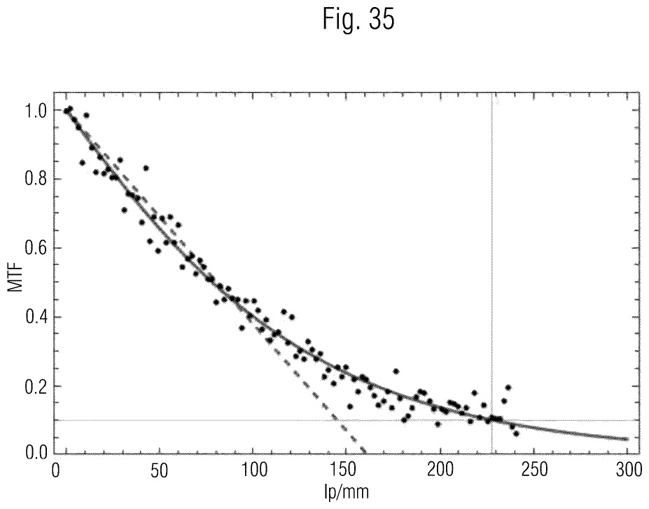

FIG. 35: A graph showing the determination of the cut-off frequency from the MTF data of aGALOF.

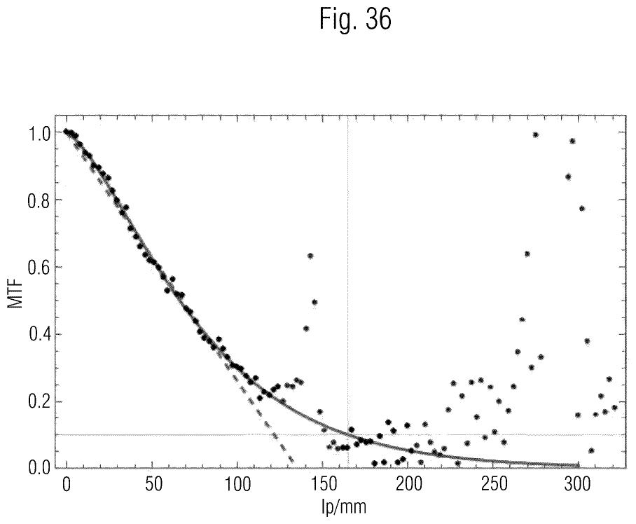

FIG. 36: A graph showing the determination of f_{cut} from the MTF data of a FOP.

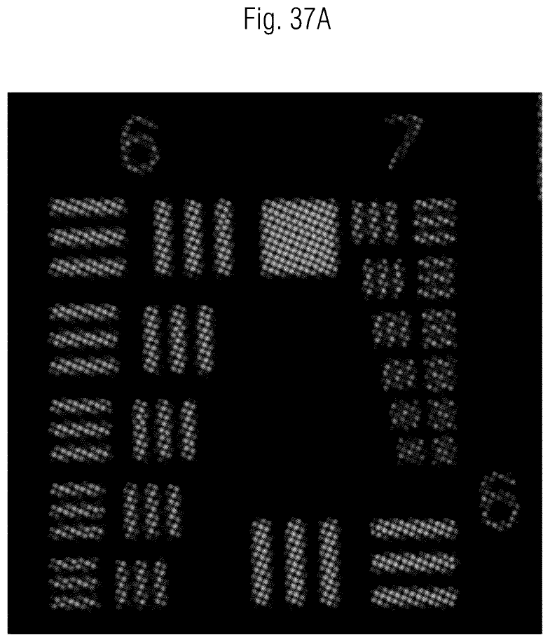

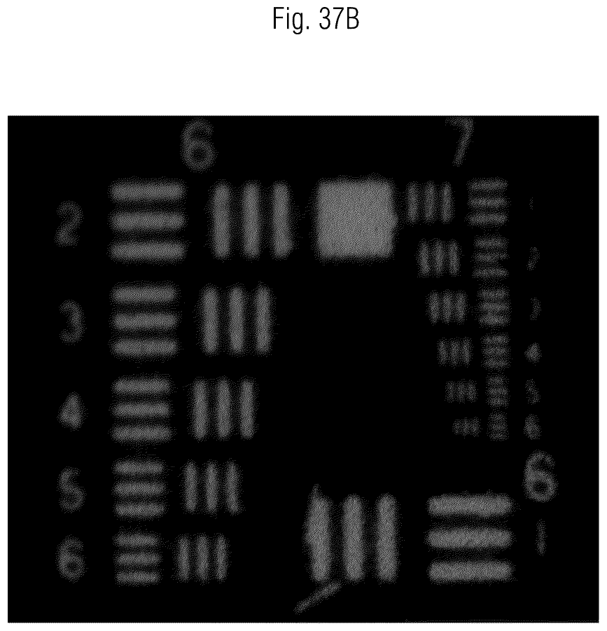

FIGS. 37A and 37B: Image of Groups 6 and 7 of the USAF51 target through different products.

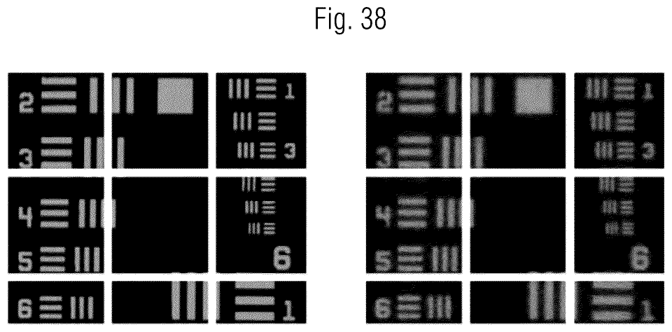

FIG. 38: Subimage partition for the MS-SSIM calculation of small diameter image guides.

FIG. 1 shows various principal examples of waveguides 1 which can be used in particular as image guides. The waveguides 1 shown in cross-section each comprise a plurality of structural elements 10, each of which extends along the direction of transport of the waveguide 1, which is perpendicular to the figure here, and each of which extends proportionally over the cross-section thereof. Each of the structural elements 10 thus defines a cross-sectional region 20, i.e. a proportion of the area of the cross-section of the waveguide 1. The examples of waveguides 1 shown each have at least two different types of structural elements, which differ in their refractive indices. These principle embodiments serve to illustrate some variants of non-uniformity and may deviate in detail from a deterministic positioning of structural elements determined according to

the invention.

The waveguide shown in cross-section in FIG. 1(a) has a structural element of a first type 10a formed as a base body, which accommodates a plurality of structural elements of a second type 10b. The structural elements of the second type 10b may thereby be formed, for example, as cavities or hollow channels extending along the transport direction in the structural element of the first type 10a. In this case, the structural element of the first type 10a formed as a base body comprises a first material having a first refractive index, and the structural elements of the second type 10b formed, for example, as cavities form the second refractive index, for example, by the air or another gas contained therein. In this case, the cross-sectional region 20 of the structural element of the first type 10a corresponds to the cross-sectional area of the waveguide minus the holes in this area defined by the cavities, while the cross-sectional regions 20 of the structural elements of the second type 10b each correspond to the cross-sectional area of the cavities. However, the cavities in the main body may also be filled with a second material, such that the structural elements of the second type 10b correspond to the filled cavities. As schematically shown in the figure, the cross-sectional regions 20 of the structural elements of the second type

10b are non-uniform in that their positions are non-uniformly distributed over the cross-section, in particular do not lie on a periodic grid. At the same time, however, the positions of the structural elements are unambiguously determined by a predetermined rule, as explained in more detail herein.

The waveguide shown in cross-section in FIG. 1(b) has two types 10a, 10b of structural elements, namely again one structural element 10a formed as a base body and having a first refractive index, but a plurality of structural elements 10b having a second refractive index different therefrom. In the example shown here, the cross-sectional regions 20 of the structural elements of the second type 10b are not only non-uniformly arranged, but also have non-uniform geometries, in this case non-uniform diameters, in which case there are a limited number, namely two, different diameters. The non-uniformity of the arrangement and/or the non-uniformity of the geometries is in this case clearly determined by a predetermined rule.

The waveguide shown in cross-section in FIG. 1(c) again has two types 10a, 10b of structural elements, wherein the cross-sectional regions of the structural elements of the second type 10b are each arranged within a structural element of the first type 10a, particularly as core-sheath systems. Thus, in this case, a plurality of structural elements of the first type 10a and a plurality of

structural elements of the second type 10b are provided. The structural elements or their cross-sectional regions are formed non-uniformly in that the structural elements of the first type 10a (which accommodate the structural elements of the second type 10b) are arranged non-uniformly, in particular aperiodically, over the cross-section of the waveguide, this arrangement being
determined by a predetermined rule.

The waveguides shown in cross-section in FIGS. 1(d) and (e) correspond in some aspects to the waveguides shown in FIGS. 1(a) and (b), respectively, but having structural elements of three types 10a, 10b, 10c having different refractive indices. In particular, cavities in the structural element 10a formed as a base body may be filled with different media. Accordingly, the structural elements 10b, 10c have in particular a non-uniformity in that their refractive index differs from each other, wherein the determination of which of the structural elements formed as a cavity receives which refractive index may follow a predetermined rule.

FIG. 2 shows two further examples of waveguides 1 which can be used in particular as image guides. The waveguides 1 again comprise a plurality of structural elements 10, each of which extends from a proximal end 2 to a distal end 4 of the waveguide 1 along the transport direction 5 and is, for example, rod-shaped.

The waveguide shown in FIG. 2(a) has a plurality of structural elements of a first type 10a and a plurality of structural elements of a second type 10b. In this example, the cross-sectional regions of the structural elements are arranged on a periodic lattice. However, the structural elements have a non-uniform arrangement in that the structural elements of the first type 10a and the second type 10b, and thus the refractive indices, are non-uniformly arranged and/or distributed,

the arrangement and/or distribution being in turn uniquely determined by a predetermined rule.

The waveguide shown in FIG. 2(b) again comprises a plurality of structural elements 10 arranged on a periodic lattice, wherein in this example the cross-sectional regions of the structural elements have non-uniform geometries. In particular, the geometries may differ in that the diameters of the structural elements or their cross-sectional regions differ from each other. This form of non-uniformity may be clearly defined by a predetermined rule. Furthermore, the structural elements 10 may exhibit a non-uniformity, in particular a predetermined non-uniformity,

in that the refractive indices of the structural elements differ from one another. In this respect, a discrete number of different refractive indices, for example two, three, four, etc., but in principle also a continuous variation of the refractive index may be provided.

FIG. 3 shows a further cross-section of a waveguide which corresponds in some aspects to the waveguide shown in FIG. 2(a). The waveguide shown in FIG. 3 has a plurality of, in particular rod-shaped, structural elements 10, namely a plurality of a first type 10a and a plurality of a second type 10b, the structural elements 10 being arranged in cross-section on a periodic lattice, which in this example corresponds to a hexagonal lattice. Accordingly, it is envisaged that at least one of

the structural elements 10, or its cross-sectional area 20, is equidistant from, and preferably adjacent to, six immediately adjacent structural elements 10, or their cross-sectional areas 20.

With reference to FIGS. 4 and 5, examples are given below of how structural elements may be formed non-uniformly but uniquely defined by a predetermined rule. For this purpose, a rule may be provided for unambiguously defining a characteristic number, e.g. position, type, refractive index or even geometry, the rule may comprise a deterministic sequence (e.g. Halton sequence). The sequence forms a component of the deterministic rule described in more detail herein for specifying the characteristic number for the structural elements. For a better understanding, the rule is described in individual steps, whereby in particular the overall structure of the waveguide

defined by the steps is decisive, the determination of which may precede the manufacture of a waveguide, such that the overall structure of the waveguide is unambiguously predetermined.

For a waveguide according to the invention, for example, an available area, for example the cross-sectional area of the waveguide, is filled with structural elements at positions which can be

determined in this way, according to predetermined parameters and according to a deterministic rule. These parameters generally comprise the dimensions of structural elements, in particular shape and size, as well as information, for example, on their position and spacing, as well as the filling factor, which indicates the proportion of the surface which is to be filled with structural elements of one or more types.

For example, for a round shape of a waveguide 1 (cf. FIG. 3), for example also a preform therefor (cf. FIG. 10), with a predetermined arrangement and number of structural elements (here in the example the same diameter, hexagonally densest packing), structural elements 10b may be selected for a predetermined filling factor according to a deterministic algorithm (e.g. comprising a Halton sequence), which are occupied from a medium with, for example, a second refractive index.

For this purpose, points 102 may be generated in the square 100 enclosing the round shape of the waveguide 1, for example, according to a 2D halftone sequence. The values of the sequence lie in the range [0,1)×[0,1) and may be scaled according to the dimensions of the given area of the waveguide.

The Halton sequence is the multidimensional extension of the one-dimensional van der Corput sequence to different bases: The van der Corput sequence xₙ=ϕ_{b}(n) to the base b is defined by the inverse of the base b representation of a number n: For example, any positive integer n>=0 can be represented as a sum to a base b>=2:

$$n = {\sum }_{k = 0}^{m - 1} {a}_{k} ( n ) {b}^{k}$$

where the coefficients aₖ(n) are elements from the complete remainder system modulo b ( [symbol] _{bb}=(0,1, . . . , bb−1)), and m is the smallest integer such that aⱼ(n)=0 for all j>m. The van der Corput sequence is then defined by the radical inverse function in base b:

$${ϕ}_{b} ( n ) = {\sum }_{k = 0}^{m - 1} {a}_{k} ( n ) {b}^{- k - 1}$$

where b is a prime number.

Since the structure elements 10 are located on predefined places, and the sequences, cover the complete range [0,1)×[0,1), the following assignment takes place: The sequence elements are passed through in sequence. The assignment to a structural element, in particular to a second type 10b, is made by means of the smallest Euclidean distance. Sequence elements which are thus assigned to already selected structure elements, or which lie outside the arrangement, are ignored and the process continues with the next sequence element. This is continued until the number of structural elements corresponding to the desired fill factor, in particular of the second type 10b, has been selected.

This is illustrated by two embodiments for clarity.

A first embodiment example shows a waveguide or preform for a waveguide 1 in a round shape (FIG. 4), which is formed from at least two types of, also round, structural elements with two different refractive indices, which are predetermined in hexagonal packing or arrangement.

This arrangement is now determined according to the specifications of a deterministic sequence with the two refractive indices occupied until a predetermined degree of filling is reached. Thereby certain occupied structural elements receive one refractive index, the others the other.

This may be done under the following conditions: The structure elements which are closest to a sequence point 102 are occupied (e.g. assigned to a type 10b), provided that the sequence point lies within the round shape and the associated positions or structure element is not already occupied (e.g. assigned to a type 10b). In these cases, the sequence point is discarded and the next one is used in the sequence. Thus a first point is determined with the deterministic sequence and scaled into the form (black point), the above conditions are checked and in this first case the grey structure element is occupied. The following points are treated accordingly.

If there are further sequence points 102 outside of the round shape or duplication here, these sequence points 102 are discarded and the next sequence point 102 is continued until a predetermined fill level is reached.

It shows the figures to discard points 102v (retained here) outside the round shape or double point, and a result for a fill level of 50%.

A further example of an embodiment (FIG. 5) shows the occupation of a given surface. The aim here is, for example, to position structural elements, for example holes with a diameter, on a square plate 110 of edge length D according to the Halton sequence for a laser filamentation or drilling process. Here, the sequence points 112 are scaled from the range of values [0,1) to the dimensional range [−D/2, D/2) of the area specified herein. This is done until a predefined fill level is reached. The fill ratio is the ratio of the area of the sum of the holes to the substrate area. The

holes can be placed according to the sequence points (FIG. 5a). Alternatively, the sequence points can be rounded to the diameter of the holes (FIG. 5b). If it is not desired that the holes overlap (overlapping pairs of holes 114), such sequence points should be discarded. Double placements (FIG. 5b), are discarded accordingly and advanced further in the sequence. Likewise, there may be further specifications here which define, for example, a minimum spacing of the
structural elements.

It is understood that the method described in more detail above and illustrated in more detail by 2 examples can also be applied without restriction to further possible variations for structural elements with more than two refractive indices and/or varying or variable geometry, dimension, e.g. two or more diameters and/or shape or a combination thereof on any, possibly predetermined, surface or can clearly predetermine its structure. The conditions for the occupancy or occupiability of the available surface are then to be adapted or extended accordingly on a case-by-case basis in order to achieve a desired, required occupancy.

With reference to FIG. 6, a waveguide according to the invention in particular satisfies a certain homogeneity criterion with respect to the non-uniformity of the structural elements and preferably with respect to the image sharpness in the case of a waveguide designed as an image guide.

For example, a distribution of area contents corresponding to or uniquely assignable to the cross-sectional areas of the structural elements may satisfy a certain condition. Shown are exemplary variances of the distributions of the area contents of the Voronoi areas related to the square A of the total area of the cross-section to be occupied (normalized variance V=σ/A²) to the positions of the cross-sectional areas of the structural elements of at least one type plotted over the number N of structural elements of this at least one type, a logarithmic (FIG. 6a) and a double-

logarithmic representation (FIG. 6b) being shown.

A waveguide according to the invention may be characterized by a deterministic sequence as described above. Accordingly, the variance curve 200 is based on positions of the cross-sectional areas determined by means of a Halton sequence, and the variance curve 202 is based on positions of the cross-sectional areas determined by means of a Sobol sequence. For comparison, a variance curve 204 based on randomly determined positions of the cross-sectional areas and a fit curve 206 corresponding to the variance curve 204 (variance=0.38A²/N^{2,033}) are shown. It is apparent that the variance of the distribution for a waveguide according to the invention (for each N) is smaller than the variance for a waveguide with random disorder.

It should be noted that the curves shown are based on distributions that span the range of values from [0,1).

FIGS. 7 and 8 show exemplary Voronoi surfaces 210 to positions 212 of cross-sectional areas of structural elements, for waveguides with round cross-section (FIG. 7) and square cross-section (FIG. 8, which underlie FIG. 6). FIGS. 7a, 8a show positions 212 and Voronoi surfaces 210 based on a Halton sequence and FIGS. 7b, 8b based on a Sobol sequence, each corresponding to the non-uniformity of a waveguide according to the invention. For comparison, FIGS. 7c, 8c show positions 212 and Voronoi surfaces 210 based on a random arrangement and FIGS. 7d, 8d based on a periodic arrangement. It is evident that waveguides according to the invention are characterized in that the structural elements, in particular their cross-sectional regions, are formed non-uniformly, but with a higher homogeneity than in the case of random arrangement.

FIG. 9 shows steps of a method of manufacturing a waveguide according to a multi-draw method. In this process, a plurality of waveguides 1 are assembled to form a preform 30 and drawn into length (FIG. 9a). The waveguides 1 may be, for example, an arrangement of structural elements 10, 20 or, 10a, b, for example, according to FIG. 3, or alternative arrangements, for example, according to those shown in FIG. 1(a) to (e), which may be already drawn out in a known manner.

The assembled and elongated waveguides (“multi-fiber”) are then disassembled into sections and again assembled into a preform 40 (FIG. 9b, “multi-multi-assembly”). The preform 40 can then again be drawn to length (FIG. 9c), and if necessary again broken down into sections and assembled (FIG. 9d). Finally, the assembly thus obtained can be fused by applying heat and/or pressure, and in particular under vacuum (FIG. 9e).

With reference to FIG. 10, the assembled waveguides (“Multi-Fiber”, here “M1”) drawn to length can be assembled untwisted relative to one another (FIG. 10a) or, in particular in a predefined manner, rotated relative to one another (FIG. 10b) during assembly into a further preform.

Furthermore, during the assembly, sections from at least two different assembled waveguides (“M1”, “M2”) drawn into length can be assembled untwisted (FIG. 10c) or, in particular in a predefined manner, rotated relative to one another (FIG. 10d). Analogous to the arrangements

shown in FIG. 10a, b, the waveguides can also be or are arranged untwisted or, in particular in a predefined manner, rotated relative to one another when the first preform is assembled. In the case where a preform is assembled from portions of at least two different waveguides (“M1”, “M2”), the arrangement of these different waveguides may be in accordance with a previously described arrangement of different types of structural elements (e.g. FIG. 3), and thus again be uniquely determined by a predetermined rule.

With reference to FIGS. 11 to 14, various embodiments of the non-uniformity of the structural elements according to the invention will be discussed again below by way of example. As described, the structural elements, in particular their cross-sectional regions, are characterized on the one hand by a non-uniformity in relation to one another, and on the other hand by a regularity to the effect that the non-uniformity of the structural elements is clearly predetermined, in particular is deterministic and/or reproducible and does not follow chance.

For example, the structural elements or their cross-sectional regions may have a non-uniform arrangement that is uniquely determined by a predetermined rule, have mutually non-uniform geometries that are uniquely determined by a predetermined rule, and/or have mutually non-uniform refractive indices that are uniquely determined by the predetermined rule.

FIG. 11 shows, by means of a tree diagram, various possibilities for realizing a non-uniform arrangement which is clearly determined by a predetermined rule. FIG. 11a shows as a starting point a structural element 10a, which can be formed, for example, as a matrix material (it is also possible that the structural element 10a is formed as air or is absent). FIG. 11b shows a further

starting point derived therefrom with the structural element 10a as well as a plurality of periodic positions P for occupation with structural elements which then have a periodic positioning. FIG. 11d shows a further starting point derived from FIG. 11a with the structural element 10a as well as a plurality of aperiodic positions P for occupation with structural elements to obtain aperiodic positioning. Starting from the starting points shown in FIGS. 11b and 11d, waveguides according to the invention are obtained by occupying the positions P with structural elements, as will be described in more detail below.

Starting from FIG. 11b, FIG. 11c shows a waveguide 1 having structural elements 10b, 10c whose cross-sectional regions have periodic positioning and/or lie on periodic positions. The waveguide shown in FIG. 11c has three types of structural elements 10a, 10b, 10c, each of which may have a different refractive index. For example, the structural element 10a may be formed as a matrix material and the structural elements 10b and 10c may be voids in the matrix material filled with materials of different refractive indices.

However, it is also possible that one of the materials of the structural elements 10b and 10c in turn corresponds to the matrix material of the structural element 10a or that the (filled) cavities corresponding to these structural elements are absent from the matrix material (compare further below to FIG. 13a). It is also possible that the structural element 10a is formed as air or is absent and the structural elements 10b and 10c are adjacent to each other (compare further below to FIG. 14a).

The waveguide 1 shown in FIG. 11c has structural elements 10b, 10c with a periodic positioning. However, the structural elements 10b, 10c are of different types and the occupancy of the different types on the regular lattice is non-uniform but determined by a predetermined rule. In particular, the variation of the structural elements 10b, 10c among each other is thus non-uniform but determined by a predetermined rule. In particular, the structural elements 10b, 10c may be described as deterministically disordered. FIG. 11c thus shows a case of a waveguide 1, wherein the structural elements or their cross-sectional regions have a non-uniform arrangement which is

uniquely determined by a predetermined rule. The term arrangement is to be understood here as meaning that the selection or occupancy of the various types of structural elements 10b, 10c at
the respective periodic positions is non-uniform but is determined by the predetermined rule, i.e. is not random.

It is further possible that the structural elements 10b, 10c do not differ with respect to their refractive indices, e.g., have the same refractive index or are made of the same material, but vary with respect to other aspects (see FIG. 12 below). It is further possible that the structural elements 10b, 10c differ with respect to their refractive indices as well as with respect to other aspects.

Starting from FIG. 11d, FIG. 11e shows a waveguide 1 having two types of structural elements, namely the structural element 10a, which may be formed, for example, as a matrix material, and a plurality of structural elements 10b, which may be formed, for example, as, in particular, filled cavities in the matrix material. In this case, the cross-sectional regions of the structural elements 10b are positioned aperiodically. The positioning of the structural elements 10b may now represent the non-uniformity in this case, which is determined by a predetermined rule. In particular, the structural elements 10b of the second type may have non-uniform positions, but positions determined by a predetermined rule. Thus, FIG. 11e shows a case of a waveguide 1 wherein the structural elements or their cross-sectional regions have a non-uniform arrangement which is clearly determined by a predetermined rule. The term arrangement is to be understood here as meaning that the or some of the structural elements or their cross-sectional regions are

positioned aperiodically, the positions being determined by the predetermined rule, i.e. not being random. In the case of FIG. 11e, it is provided in particular that the structural elements 10b of the second type have a uniform refractive index, have uniform geometries and/or are uniformly formed with respect to further aspects, in particular are identically formed. In this case, it is possible to speak of a uniform occupancy of the aperiodic positions.

In contrast, FIG. 11f shows, starting from FIG. 11d, a waveguide 1 in which an aperiodic positioning of structural elements with simultaneously different types of structural elements 10b, 10c is provided. In this case, the non-uniformity, which is clearly determined by a predetermined rule, can lie in the aperiodic positioning of the structural elements 10b, 10c or in the occupancy, i.e. the variation of the structural elements 10b, 10c among each other, or lie both in

the positioning and in the occupancy.

FIG. 12 shows different possibilities of variations, which structural elements can have among each other (middle row) as well as exemplary, not to be understood conclusively, combination possibilities of the variations (lower targets). The variations shown can be used in particular for an occupation of positions with structural elements, which is formed unevenly, but is clearly determined by a predetermined rule. Structural elements whose cross-sectional regions are located on periodic or also aperiodic positions, e.g. within a matrix material, can, for example, vary among themselves with respect to their shape, vary with respect to their type or refractive index, vary with respect to their substructure and/or vary with respect to their rotation (and/or local position).

For example, variations of the geometries of the structural elements, in particular their cross-sectional regions, can be formed as variations of the shape (number of corners, diameter). Variations of the geometry can also be formed as variations of the substructure. A substructure can in particular be that a structural element, in particular its cross-sectional region, has at least two different regions of different refractive indices, in particular a core and a surrounding cladding (core-cladding system).

In combination, for example, a first type of structural element can have a polygonal shell and/or a polygonal core, and a second type of structural element can have a round shell and a polygonal core (bottom row, first column). These two types of structural elements can then serve, for example, to occupy periodic or also aperiodic positions.

Further, for example, a first type of structural elements may have a first refractive index and a first diameter, and a second type of structural elements may have a second refractive index and a second diameter (bottom row, second column); or a first type of structural elements a core-cladding system having a core with a first diameter and a second type of structural elements a core-cladding system having a core with a second diameter (bottom row, third column); or a first type of structural elements a core-cladding system having a core with a first refractive index and a second type of structural elements a core-cladding system having a core with a second refractive

index (bottom row, fourth column); or a first type of structural element having a first diameter and a rotation about a pivot point external to the structural element and a second type of structural element having a second diameter and a rotation about a pivot point external to the structural
element (bottom row, fifth column), or a first type of structural element having a core-cladding system with a centered core and a second type of structural element having a core-cladding system with a core with a rotation about a pivot point external to the core (bottom row, sixth column), and the like.

FIG. 13a shows a waveguide 1, each of which is similar in some aspects to the waveguide of FIG. 11c. The waveguide has a first structural element 10a, which may be formed, for example, as a matrix material. Further, the waveguide comprises a plurality of structural elements 10b, which may be formed, for example, as filamentary cavities in the matrix material. The structural elements 10b are located in periodic locations, but not all periodic locations are occupied by a structural element. FIG. 13a thus shows a case of a waveguide 1, wherein the structural elements or their cross-sectional regions have a non-uniform arrangement which is clearly determined by a predetermined rule. The term arrangement is to be understood here in the sense that the or some of the structural elements or their cross-sectional regions are located on periodic places, wherein

some of the periodic places are occupied and some of the periodic places are unoccupied, and the occupancy is uniquely determined, formed by a predetermined rule, i.e. is not random.

FIG. 13b shows a waveguide 1 which is in each case similar in some aspects to the waveguide of FIG. 11f. The waveguide comprises a first structural element 10a, which may be formed, for example, as a matrix material. Further, the waveguide comprises a plurality of structural elements 10b having a first diameter and a plurality of structural elements 10c having a second diameter. In this example, the structural elements are positioned aperiodically, wherein the aperiodic positioning may be non-uniform but clearly defined by a predetermined rule. FIG. 13b thus shows a case of a waveguide 1, wherein the structural elements or their cross-sectional regions have a non-uniform arrangement which is uniquely determined by a predetermined rule. In this case, the term arrangement is to be understood in the sense that the or some of the structural elements or their cross-sectional regions are positioned aperiodically, the aperiodic positions being determined by the predetermined rule, i.e. being non-random, and/or wherein the structural elements have a variation among themselves which is formed non-uniformly but uniquely

determined by a predetermined rule, the variation being formed as two types of structural elements, e.g. having different diameters.

FIG. 14 shows some waveguides 1, each with a plurality of structural elements of a first type and a plurality of structural elements of a second type (and sometimes further types in FIG. 14d). In particular, the waveguides 1 shown here do not have any matrix material (thus, in particular, they are also not formed as faceplates), rather the structural elements are adjacent to each other. The waveguides 1 shown in FIG. 14 have in common that the structural elements of the different types, in particular their cross-sectional regions, are periodically positioned, but the occupancy of the periodic positions by the types of the structural elements is formed unevenly, but clearly determined by a predetermined rule. The waveguides 1 shown in FIG. 14 are thus characterized in that the structural elements or their cross-sectional regions have an uneven arrangement which

is unambiguously determined by a predetermined rule, the term arrangement being understood here to mean that the selection or occupancy of the various types of structural elements at the periodic positions is uneven but determined by the predetermined rule, i.e. is not random.

FIG. 14a shows approximately a waveguide 1 having a plurality of structural elements 10a and a plurality of structural elements 10b having different refractive indices.

FIG. 14b shows a waveguide 1 having a plurality of structural elements 10d and a plurality of structural elements 10e, which have different refractive indices and a different substructure, the substructure being defined by sub-structural elements 10a and 10b (having refractive indices a and b) and 10a and 10c (having refractive indices a and c), respectively. The substructure here is that the structural elements 10d and 10e are formed as core-shell systems, with the cores being different.

FIG. 14c similarly shows a waveguide 1 having a plurality of structural elements 10d and a plurality of structural elements 10e, which have different refractive indices and a different substructure, the substructure being defined by the sub-structural elements 10a and 10b (having refractive indices a and b) and 10c and 10b (having refractive indices c and b), respectively. The substructure here is that the structural elements 10d and 10e are formed as core-cladding systems, with the claddings differing.

FIG. 14d similarly shows a waveguide 1 having a plurality of structural elements 10e, a plurality of structural elements 10f, a plurality of structural elements 10g, and a plurality of structural elements 10h, which have different refractive indices and a different substructure, wherein the substructure is represented by the sub-structural elements 10a and 10b (having refractive indices a and b), resp. 10a and 10c (having refractive indices a and c) and 10b and 10d (having refractive indices b and d) and 10c and 10d (having refractive indices c and d), respectively. The substructure here is that the structural elements 10e, 10f, 10g and 10h are formed as core-shell systems, with both the shells and the cores being different.

FIG. 14e shows a waveguide 1 having a plurality of structural elements 10c and a plurality of structural elements 10d having different geometries and a different substructure, wherein the substructure of the structural element 10c is defined by the substructural elements 10a and 10b (having refractive indices a and b and a first core diameter), and the substructure of the structural element 10d is defined by the substructural elements 10a and 10b (having refractive indices a and b and a second core diameter).

FIG. 14f shows a waveguide 1 having a plurality of structural elements 10c and a plurality of structural elements 10d, which have different geometries and a different substructure, wherein the substructure of the structural element 10c is defined by the substructural elements 10a and 10b (having refractive indices a and b and a centrally positioned core), and the substructure of the structural element 10d is defined by the substructural elements 10a and 10b (having

refractive indices a and b and an eccentrically positioned core).

FIG. 15a and FIG. 15b show photographs as examples of practically manufactured waveguides 1 with a monolithic base body as a structural element of the first type 10a in which a plurality of filament-shaped channels as structural elements of the second type 10b have been introduced by

means of laser filamentation, these channels having an aperiodic positioning and the aperiodic positions being non-uniform but clearly defined by a predetermined rule. However, in the case of laser filamentation, it may also be provided, for example, that the laser scans the substrate line by line, resulting in a periodicity or a grid. In particular in such a case, the structural elements of the second type 10b formed as filamentary channels may also be positioned on periodic locations,
wherein some of the periodic locations are occupied and some of the periodic locations are unoccupied and the occupancy is uniquely determined by a predetermined rule.

FIG. 16a shows a photograph as an example of a practically manufactured waveguide 1 having a plurality of fibers with a first refractive index as structural elements of the first type 10a and a plurality of fibers with a second refractive index as structural elements of the second type 10b, and an enlarged view and sketches thereof in FIG. 16b. In this case, the fibers of the structural elements 10a and 10b are adjacent to each other and are positioned according to a periodic lattice, wherein the occupation of the positions by the types 10a and 10b is formed unevenly but clearly determined by a predetermined rule. The structural elements of the first type 10a and of the second type 10b may be surrounded by a structural element of a third type 10c formed as a cladding tube. The cladding tube may have a refractive index which is lower than both the

refractive index of the structural elements of the first type 10a and the refractive index of the second type 10b.

FIG. 17 shows a photograph of the waveguide 1 of FIG. 16a in its application as an image guide, transmitting an image showing the numeral 5. Due to the non-uniformity in the arrangement of the

structural elements, an image transmission with a high resolution based on the phenomenon of transverse Anderson localization is achieved here. At the same time, locally controllable image sharpness and homogeneity is made possible due to the arrangement according to the predetermined rule.

In summary, a waveguide 1 may be provided, for example, wherein the structural elements, in particular their cross-sectional regions, have a non-uniform arrangement which is uniquely determined by a predetermined rule, wherein the non-uniform arrangement, which is uniquely determined by the predetermined rule, is formed
(a) as a periodic positioning of structural elements, in particular cross-sectional regions
thereof, wherein the periodically positioned structural elements have a variation among each other which is non-uniform but uniquely determined by a predetermined rule,
wherein the variation of the periodically positioned structural elements among each other may be formed as a variation of the type of the structural elements, the refractive index of the structural elements and/or the geometry (e.g. the shape, the diameter and/or the substructure) of the structural elements,
(b) as an aperiodic positioning of structural elements, in particular cross-sectional regions thereof, wherein the aperiodic positions of the structural elements are formed non-uniformly but unambiguously by a predetermined rule,
wherein optionally the structural elements also have a variation among each other which is non-uniform but unambiguously defined by a predetermined rule,
and/or (c) as a positioning of structural elements, in particular cross-sectional regions thereof, on periodic sites, wherein some of the periodic sites are occupied and some of the periodic sites are unoccupied and the occupancy is unambiguously determined by a predetermined rule,
wherein optionally the structural elements further have a variation among themselves which is non-uniform but clearly defined by a predetermined rule.

As previously described, the structural elements may also differ from each other in their shape or geometry. In particular, in the case that the waveguide is formed as a fiber rod by means of a preform fiber drawing process, which may be repeated several times, the initial shapes or geometries may be retained, but may also appear as deformed in the waveguide due to the thermal influences and the mechanical influences that may occur in the process. In particular, at least some structural elements may assume a hexagonal and/or hyperbolic polygonal shape, in particular triangular or hexagonal. The introduction of structural elements by means of laser processes can also comprise such geometry variations, for example by guiding the or a laser beam or the laser radiation accordingly and/or optically adjusting its beam profile.

In some embodiments, the waveguides have a cut-off frequency (f_cut) greater than 170 line pairs per millimeter (lp/mm), greater than 180 lp/mm, greater than 190 lp/mm, greater than 200 lp/mm, greater than 210 lp/mm, greater than 220 lp/mm, greater than 230 lp/mm, greater than 240 lp/mm, greater than 250 lp/mm, greater than 275 lp/mm, greater than 300 lp/mm, greater than 400 lp/mm, greater than 500 lp/mm, greater than 600 lp/mm, greater than 700 lp/mm, greater than 800 lp/mm, greater than 900 lp/mm, and/or less than 1,000 lp/mm.

According to another aspect of the invention, the waveguides have an area under the MTF calculated up to the cut-off frequency (f_cut) greater than 80 lp/mm, greater than 90 lp/mm, greater than 100 lp/mm, greater than 125 lp/mm, greater than 150 lp/mm, greater than 175lp/mm, greater than 200 lp/mm, greater than 225 lp/mm, greater than 250 lp/mm, greater than 275 lp/mm, greater than 300 lp/mm, greater than 325 lp/mm, greater than 350 lp/mm,

greater than 375 lp/mm, greater than 400 lp/mm, greater than 425 lp/mm, greater than 450 lp/mm, greater than 475 lp/mm, and/or less than 500 lp/mm.

The MTF is a way to compare the performance of different optical systems and can be understood as the performance of the waveguide represented by a periodic sine wave pattern at different spatial frequencies, for example as shown in FIG. 18 taken from imatest.com. While at lower frequencies (compare upper and lower half of the sine pattern chart in FIG. 18) the image and object contrasts are identical, the limited resolution of the optical system leads to a blurred image at higher spatial frequencies, causing a loss in contrast. The modulation of visibility of the

amplitude decreases from 1 to 0 (as depicted in the middle graph).

The MTF at a spatial frequency f is defined as the ratio of image contrast to object contrast at the given frequency:

$$MMMMMM ( ff ) = \frac{iiiiiiiiii cccccccccciicccc ( ff )}{ccbbooiicccc cccccccccciicccc ( ff )}$$

In principle, this performance can depend on different orientations. Since also an aperture stop in an optical system constitutes a limitation of the transmission of higher spatial frequency components, the MTF resulting from this can be considered an upper bound (diffraction limit) for any imaging system. This can be calculated from the absolute value of the optical transfer function (OTF), which is the normalized autocorrelation of the exit pupil. For a rectangular and circular shaped aperture, the diffraction limited MTFs are depicted in FIG. 19 taken from https://spie.org/publications/tt52_151_diffraction_mtf?SSO=1.

The apertures have the same cut-off frequency ξ_{cutoff}, which depends of the wavelength and the f-number of the system and marks the highest resolvable spatial frequency. Their shapes differ slightly due to the different aperture geometries. All real optical systems with poorer performance are below the respective lines.

The MTF is not only applicable to lens systems, but is suitable to assess any optical transfer performance, such as image transmission through coherent fiber bundles.

Note, that in addition to the MTF of the fiber bundle, the MTF of the imaging system itself (e.g. a microscope) has a contribution to the complete transmission performance. Hence, assessment should always be put into the context of the MTF of the blank target (without a waveguide).

Methods of how to measure the MTF of a real optical system are described in the ISO 12233:2017 (Photography—Electronic still picture imaging—Resolution and spatial frequency responses). We follow the so-called slanted edge method, where the MTF in one dimension is deduced from a knife-edge image, since a perfect Heaviside function comprises of all frequency components. Aberrations from the optical imaging systems will result in blurring of the edge, due to a suppressed transmission of higher frequency components.

The derivative of the measured edge spread function (ESF), is the line spread function (LSF), which must be Fourier transformed to receive the MTF (see FIG. 20 taken from Hang Li, Changxiang Yan, and Jianbing Shao, “Measurement of the Modulation Transfer Function of Infrared Imaging System by Modified Slant Edge Method,” J. Opt. Soc. Korea 20, 381-388(2016)).

The edge should be slightly tilted (5-10°) with respect to pixel orientation of the camera system, in order to achieve sub-pixel resolution, when integrating the pixel intensities on a line, perpendicular to the edge orientation. The pixel size of the detector, or the effective pixel size after an optical magnification, constitutes an upper bound for the smallest resolvable spatial frequency (Nyquist limit). Hence, when measuring and evaluating the MTF of an image guide, it has to be ensured, that the optical inspection system is not limiting the resolution power. This can be done by a comparison with a blank target as reference. The above mentioned effect can be seen in FIG. 21, where the cutoff frequency shifts to higher values, with increasing magnification, hence decreasing effective pixel size.

As mentioned beforehand, the pixel size of the image constitutes an upper boundary for the MTF. In order to ensure, that an observed loss in transmission quality is due to the performance of the optical system, rather than the sampling of the image, a series of images for the MTF calculation with increasing resolution is taken, as shown in FIG. 26. The change in magnification between

successive images shall be between 1.5 and 2. Illumination conditions (lambertian white light source in through light configuration) are adjusted to avoid pixel saturation in the lowest magnification image by checking the histogram of the image and making sure that it is not clipped at the maximum value (e.g. 2⁸−1=255 for an 8-bit image), and are kept constant throughout the series. The image guide is butt-coupled (physical contact) to the black/white transition of the target without any immersion fluid.

The calculated MFTs are shown in FIG. 34. It is obvious, that images with high resolution suffer from strong noise in the high frequency range, while low resolution images have an artificially lower cutoff-frequency due to the Nyquist limit. The data we use, for the MTF calculation is thus determined in the following way.

For a set of MTF curves from images with increasing resolution, a linear regression of the form

$$y y = 1 - ii xx$$

is fitted to a subset of the data fulfilling the condition yy≥0.4 & xx≤250 llll/iiii. From the negative linear slope an approximated cutoff-frequency ff_{cccccc_llllll}=ii⁻¹ is determined. For the dataset shown in FIG. 34, they are 83.3, 130.8, 161.0, 161.3, and 171.9 lp/mm, respectively. We choose now from two neighboring datasets where the difference in ff_{cccccc_llllll} is less than 10% of the lower value for the first time, the one with the lower resolution, since this can be regarded as the
image resolution, where the transmission properties of the image-guide dominate the optical performance. In the upper case, this corresponds to the data with a magnification of 500×.

To determine the cutoff frequency and thus the resolution of the image guide from the MTF, we start with limiting the full data set to 1.5 times ff_{cccccc_llllll} on the frequency axis, due to increasing

noise in the high frequency range with little amplitude. To this subset of data, we fit a function with a double exponential decay of the form

$$y y ( x x ) = AA {ii}^{- k k {1}^{xx}} + ( 1 - A A ) i {i}^{- k k {2}^{xx}}$$

and define the intersection yy(ff_{cccccc})=0.1 as the cutoff-frequency ff_{cccccc}. For the 500× magnification image, this is shown in FIG. 35. where the dashed red line is the linear regression
curve (ff_{cccccc_llllll}=161.0 lp/mm), while the solid red line is the double exponential fit to the data points (black). The cutoff frequency ff_{cccccc}=227.5 lp/mm corresponds well to the resolved USAF target group 7 element 6 (G7E6-228 lp/mm) shown in FIG. 37B. The area under the fit-curve up to ff_{cccccc} amounts to 94.97 lp/mm.

Since the determination of the MTF is based on a Fourier analysis, the investigation of fiber bundles with a visible periodic arrangement suffers from significant fixed pattern noise, especially, when they incorporate EMAs. The eminent frequency components corresponding to the fiber pitch, cause resonances in the MTF, with amplitudes, that can exceed 1. To circumvent these artifacts, a standard peak-finding algorithm with a Gaussian filter width of 10 lp/mm is applied to the data, to identify local maxima. Data, within a symmetric region of 3 times the full width at half

maximum of the peaks are discarded. Afterwards, the aforementioned procedure to determine the characteristics of the MTF is applied. The results for an analyzed fiber bundle with 3 μm fiber pitch and EMAs is depicted in FIG. 36, where the blue data points are ignored.
The corresponding values are f_{cut_lin}=135.3 lp/mm, f_{cut}=165.0 lp/mm, and an area=75.8 lp/mm. Here again, the determined cutoff frequency corresponds well to the discernable line pairs of G7E3 (161.3 lp/mm) in FIG. 37A.

In order to determine the Fourier coefficients for the relative contrast P, a negative United States Air Force (USAF51) resolving power test target was used because it produces images with a low magnitude of noise. The elements of the Groups 6 to 9 of the USAF51 target were used for the

test to probe the values at high resolution. The normalization was carried out by comparing the results obtained for an image of the target without being viewed through a waveguide (a “blank target image”) compared to an image of the target while being viewed through a waveguide (a “sample target image”).

To calculate the relative contrast P, the coefficients of the Fourier series are obtained at every given spatial frequency for both the blank target and sample target images, and the ratio between the results obtained for 1 period is the value of P added to the final plot, as shown for example in FIG. 22.

The image capture procedure is to 1) capture pictures of the blank target image and the sample target image with the same acquisition parameters (e.g. camera contrast, illumination conditions, and exposure; 2) for each element size, acquire the grey scale profile with Image J; 3) with the

grey scale values, calculate the value of the Fourier series element corresponding to the frequency under examination; and 4) plot the ratio between the values obtained for the blank target image and the sample target image.

In some aspects of the invention, the waveguides have a relative contrast P at 114 lp/mm greater than 0.40 (i.e. 40%), greater than 0.45, greater than 0.50, greater than 0.55, greater than

0.60, greater than 0.65, greater than 0.70, greater than 0.75, greater than 0.80, greater than 0.85, and/or less than 0.90. The waveguides may have a relative contrast P at 144 lp/mm greater than 0.20 (i.e. 20%), greater than 0.25, greater than 0.30, greater than 0.35, greater than 0.40,
greater than 0.45, greater than 0.50, greater than 0.55, greater than 0.60, greater than 0.65, and/or less than 0.70. The waveguides may have a relative contrast P at 1,000 or less lp/mm that is greater than 0.05 (i.e. 5%), greater than 0.10, greater than 0.15, greater than 0.20, greater than 0.25, greater than 0.30, greater than 0.35, greater than 0.40, greater than 0.45, greater than
0.50, greater than 0.55, greater than 0.60, greater than 0.65, and/or less than 0.70. The waveguides may have a relative contrast P from 114 to 287 lp/mm greater than 0.05, greater than 0.10, greater than 0.20, greater than 0.30, greater than 0.40, greater than 0.50, greater than
0.60, greater than 0.70, greater than 0.80, and/or less than 0.90.

In certain embodiments, the waveguides have a Michelson contrast greater than 0.6, greater than 0.7, greater than 0.8, greater than 0.9, and/or less than 1.0.

The Michelson contrast is the difference in luminance of dark and bright regions of the image, and is defined as:

$$\frac{{II}_{mmmmx x} - {II}_{mmllll}}{{II}_{mmmmxx} + {II}_{mmllll}}$$

where Iₘₐₓ and Iₘᵢₙ represent the highest and lowest luminance. The contrast ranges from 0 (no contrast) to 1 (full contrast). In order to circumvent the susceptibility of this definition to pixel errors (hot or cold pixels with extreme values), we extract the maximum and minimum values from the plateaus of the integrated edge spread function within the determination of the MTF, by fitting an Error-function curve progression of the form:

$$\frac{1}{2} erf \frac{xx - {xx}_{0}}{\sqrt{2} σ σ} + 1 ( {II}_{max} - {II}_{min} ) + {II}_{min}$$

to the data, as depicted in FIG. 23. Hence, an averaging over the bright and dark areas is performed, and the procedure is less sensitive to noise.

In certain embodiments, for an image of Groups 6 and 7 of a positive or negative USAF51 target described herein, for a waveguide having a transmission length of up to 20 mm, the waveguide has a multi-scale structural similarity index measure (MS-SSIM) greater than 0.65, greater than 0.70, greater than 0.75, greater than 0.80, greater than 0.85, greater than 0.90, greater than 0.95, and/or less than 1.00. In some embodiments, for a waveguide having a transmission length of up to 50 mm, the waveguide has a MS-SSIM greater than 0.60, greater than 0.65, greater than 0.70, greater than 0.75, greater than 0.80, greater than 0.85, greater than 0.90, greater than 0.95, and/or less than 1.00. In some embodiments, for a waveguide having a transmission length of up to 100 mm, the waveguide has a MS-SSIM greater than 0.50, greater than 0.55, greater than 0.60, greater than 0.65, greater than 0.70, greater than 0.75, greater than 0.80, greater than 0.85, greater than 0.90, greater than 0.95, and/or less than 1.00. In some embodiments, for a waveguide having a transmission length of up to 1,000 mm, the waveguide has a MS-SSIM greater than 0.45, greater than 0.50, greater than 0.55, greater than 0.60, greater than 0.65, greater than 0.70, greater than 0.75, greater than 0.80, greater than 0.85, greater than 0.90, greater than 0.95, and/or less than 1.00.

The measurements conditions for the purposes of calculating the MS-SSIM herein are 300-1,000× magnification.

When comparing two images, e.g. the blank target image and the sample target image through an imaging system, there are different methods described in literature, to compare the two images and assess the quality of the sample target image. The most widely used are statistical measures like the peak signal-to-noise ratio (PSNR) or the mean squared error (MSE), but they do not correlate well with the perception of the human visual system. The assumption that the human vision is adapted to extract structural information from an image led to the development of

the structural similarity index measure (SSIM), a pixel-based comparison, which is used for measuring the similarity between two images [Zhou Wang, A. C. Bovik, H. R. Sheikh and E. P. Simoncelli, “Image quality assessment: from error visibility to structural similarity,” in IEEE Transactions on Image Processing, vol. 13, no. 4, pp. 600-612, April 2004, doi: 10.1109/TIP.2003.819861.].

For two aligned images with pixel vectors x={xi|I=1, 2, . . . , N} and y={yi|I=1, 2, . . . , N} the SSIM is defined as:

$$SSIM ( x , y ) = {[ l ( x , y ) ]}^{\text{?}} \cdot {[ c ( x , y ) ]}^{β} \cdot {[ s ( x , y ) ]}^{γ}$$

$$\text{?} \text{indicates text missing or illegible when filed}$$

with α, β, γ being the parameters to define the relative importance of the components I(x,y), c(x,y) and s(x,y), which can be understood as the measures for luminescence, contrast and structure comparison:

$$l ( x , y ) = \frac{2 {μ}_{x} {μ}_{\text{?}} + {C}_{1}}{{μ}_{\text{?}}^{2} + {μ}_{y}^{3} + {C}_{1}} ,$$

$$c ( x , y ) = \frac{2 {σ}_{\text{?}} {σ}_{y} + {C}_{2}}{{σ}_{\text{?}}^{2} + {σ}_{y}^{2} + {C}_{2}} ,$$

$$s ( x , y ) = \frac{{σ}_{\text{?}} + {C}_{2}}{{σ}_{\text{?}} {σ}_{\text{?}} + {C}_{3}} ,$$

$$\text{?} \text{indicates text missing or illegible when filed}$$

where μᵢ, σᵢ² and σᵢⱼ denote the mean values, variances and covariance of or between the respective image-vectors, while C1=(K1 L)²; C2=(K2 L)² and C3=C2/2 are small constants,
and L denotes the dynamic range of the pixel values. Since the choice C₁=C₂=0 leads to unstable measurements, K₁=0.01 K₂=0.03 is a common choice. With equal weighting of the components, this yields:

$$SSIM ( x , y ) = \frac{( 2 {μ}_{x} {μ}_{y} + {C}_{\text{?}} ) ( 2 {σ}_{\text{?}} + {C}_{2} )}{( {μ}_{x}^{2} + {μ}_{y}^{2} + {C}_{1}^{′} ) ( {σ}_{\text{?}}^{2} + {σ}_{y}^{2} + {C}_{2} )}$$

$$\text{?} \text{indicates text missing or illegible when filed}$$

The maximum value of SSIM(x,y)=1 is only achieved for identical images.

As a single scale method, the SSIM lacks the variability of the human image perception to different sampling densities or observation distances. Hence, a multi-scale expansion of the SSIM, considering image details at various resolution levels, the Multi scale—structural similarity index measure (MS-SSIM) is considered [Z. Wang, E. P. Simoncelli and A. C. Bovik, “Multiscale structural similarity for image quality assessment,” The Thrity-Seventh Asilomar Conference on Signals, Systems & Computers, 2003, 2003, pp. 1398-1402 Vol. 2, doi:10.1109/ACSSC.2003.1292216.]:

$$MS - SSSIM ( x , y ) = {[ {l}_{M} ( x , y ) ]}^{{\text{?}}_{M}} \cdot {\prod }_{j = 1}^{M} {{[ {c}_{j} ( x , y ) ]}^{{\text{?}}_{\text{?}}} [ {s}_{\text{?}} ( x , y ) ]}^{{\text{?}}_{\text{?}}}$$

$$\text{?} \text{indicates text missing or illegible when filed}$$

Here, for M−1 iterations of images low-pass filtered and downsampled by two, contrast cⱼ(x,y) and structural comparison sⱼ(x,y) is calculated along with the luminance Iₘ(x,y) of the scale M image. The weighting parameters α_{M}, βⱼ, γⱼ were calibrated by Wang et al. for M=5 to the human image perception, yielding β₁=γ₁=0.0448, β₂=γ₂=0.2856, β₃=γ₃=0.3001, β₄=γ₄=0.2363 and, α₅=β₅=γ₅=0.1333.

For our comparison, images of the Groups 6 and 7 of positive as well as negative USAF51 resolution targets groups in different magnifications were taken, where the blank target image serves as the reference image, and the one taken through the image guide is the sample target image. The target was illuminated from below with a Lambertian white light source. Magnification and illumination were not changed between images, and saturation was avoided by checking the histogram of the image and making sure that it is not clipped at the maximum value (e.g. 2⁸−1=255 for an 8-bit image). Before applying the MS-SSIM calculation, the images where aligned and cropped to the same size, using a template matching algorithm.

In case the dimensions of the image guide are too small to allow a complete visualization of all group 6 and 7 elements, the image has to be divided into a series of non-overlapping subimages (see FIG. 38). The size of the subimages is defined by the largest rectangular area that can be transmitted through the waveguide. For every pair of corresponding reference and target subimages (that again can be aligned via a template matching algorithm), the MS-SSIM and its

area percentage of the composed image are calculated. The area-weighted sum constitutes the MS-SSIM of the complete image.

Traditional fiber bundles composed of an arrangement of (fairly) regular core-cladding mono fibers that transport light by total internal reflection tend to imprint an underlying structure on the transmitted image, leading to a pixelated appearance. This is especially pronounced when EMAs (extra mural absorbers) are incorporated in the fiber bundle. This artefact known as honeycomb effect is due to the non-transmitting cladding material around the individual cores, so that only discrete positions within the observed field of view are transported. Apart from the reduction in information, this can cause issues in image processing, relevant for computer assisted diagnostics, when such transmitted images are sampled on the rectangular pattern of a sensor chip (Rongguang Liang, “Optical Design for Biomedical Imaging”, Chapter 8—Endoscope Optics, SPIE, (2011)). Hence, there is a multitude of approaches to mitigate this effect, including amongst others band pass filtering in the Fourier domain, interpolation, superposition of images with micro displacement, compressive sensing and Baysian approximations or fiber-core-targeted scanning (see Antonios Perperidis et al., Image computing for fibre-bundle endomicroscopy: A review, Medical Image Analysis, 62, p. 101620, (2020); Qian Li et al., Depixelation of coherent fiber bundle imaging by fiber-core-targeted scanning, Applied Optics, 60 (26), p. 7955 (2021); and references therein). These methods are typically time consuming and computationally expensive,

thus reducing the SNR or rendering them inapplicable for real time analysis.

Image guides where the transmission is mediated via a multi-beam interference localization phenomenon typically have an aperiodic assembly and hence a superior optical image appearance, since it lacks the above mentioned fixed pattern noise. This distinction becomes very eminent, when analyzing the discrete Fourier transform of the images as depicted in FIG. 24.

For such traditional fiber optical plate (FOP, middle column in FIG. 24) the visible periodic structure leads to a pronounced multi peak structure in the discrete Fourier transform.

As shown in the bottom graph in FIG. 24 from Example 8, the integrated line scan (top to bottom) of the FOP's FFT features apart from the central peak, at least two more sharp peaks with an amplitude of at least 25% of the central peak, and at least a distance of 10× the width of the

central peak away from said peak. These might be identified with a common peak finding algorithm, with appropriate parameter settings considering the noise level of the graph (blurring, sharpness, distance, amplitude—known to the expert). In contrast, the waveguides of the current disclosure may have an integrated line scan with zero peaks with an amplitude of at least 25% of the central peak.

The measurements made herein used either a Zeiss SmartZoom 5 microscope equipped with the objective “PlanApp D 10×/0.6 FWD 10 mm” (FIGS. 26 (Blank and FOP), 30-31, 34 and 37A) or a Keyence VHX 6000 equipped with a “VH-ZST” dual zoom objective (FIGS. 26 (TALOF), 27-29, 32-33, 35-36, 37B and 39) under Lambertianillumination.

A first embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a cut-off frequency (ff_{cccccc}) greater than 170 lp/mm.

A second embodiment of the invention relates to a waveguide (1) of the first embodiment, wherein the waveguide (1) has a cut-off frequency (ff_{cccccc}) greater than 170 lp/mm and less than

1,000 lp/mm.

A third embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a relative contrast P at 114 lp/mm greater than 0.40.

A fourth embodiment of the invention relates to a waveguide (1) of the third embodiment, wherein the waveguide (1) has a relative contrast P at 114 lp/mm greater than 0.40 and less than 0.90.

A fifth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a relative contrast P at 144 lp/mm greater than 0.20.

A sixth embodiment of the invention relates to a waveguide (1) of the fifth embodiment, wherein the waveguide (1) has a relative contrast P at 144 lp/mm greater than 0.20 and less than 0.70.

A seventh embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a relative contrast P at 1,000 or less lp/mm greater than 0.05.

An eighth embodiment of the invention relates to a waveguide (1) of the seventh embodiment, wherein the waveguide (1) has a relative contrast P at 1,000 or less lp/mm greater than 0.05 and less than 0.70.

A ninth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a relative contrast P from 114 to 287 lp/mm greater than 0.05.

A tenth embodiment of the invention relates to a waveguide (1) of the ninth embodiment, wherein the waveguide (1) has a relative contrast P from 114 to 287 lp/mm greater than 0.05 and less than 0.90.

A eleventh embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has an area under the MTF calculated up to the cut-off frequency (f_cut) greater than 80 lp/mm.

A twelfth embodiment of the invention relates to a waveguide (1) of the eleventh embodiment, wherein the waveguide (1) has an area under the MTF calculated up to the cut-off frequency (f_cut) greater than 80 and less than 500 lp/mm.

An thirteenth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a Michelson contrast greater than 0.6.

A fourteenth embodiment of the invention relates to a waveguide (1) of the thirteenth embodiment, wherein the Michelson contrast is greater than 0.6 and less than 1.0.

A fifteenth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a MS-SSIM greater than 0.65 for a transmission length of up to 20 mm, a MS-SSIM greater than 0.60 for a transmission length of up to 50 mm, a MS-SSIM greater than 0.50 for a transmission length of up to 100 mm, and/or aMS-

SSIM greater than 0.45 for a transmission length of up to 1,000 mm.

A sixteenth embodiment of the invention relates to a waveguide (1) of the fifteenth embodiment, wherein the waveguide (1) has a MS-SSIM greater than 0.65 and less than 1.00 for a transmission length of up to 20 mm.

A seventeenth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein for a waveguide (1) having a transmission length of more than 100 mm, the waveguide (1) has a MS-SSIM greater than 0.50.

A eighteenth embodiment of the invention relates to a waveguide (1) according to the seventeenth embodiment, wherein), for a waveguide (1) having a transmission length of more than 100 mm, the waveguide (1) has a MS-SSIM greater than 0.50 and less than 1.00.

An nineteenth embodiment of the invention relates to a waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has an integrated line scan with zero peaks with an

amplitude of at least 25% of the centralpeak.

A twentieth embodiment of the invention relates to a waveguide (1) according to any one of the preceding embodiments, wherein the waveguide (1) has a plurality of structural elements (10), at least two different types of structural elements being comprised, namely a first type (10a) having a first refractive index and a second type (10b) having a second refractive index.

A twenty first embodiment of the invention relates to a waveguide (1) according to any one of the preceding embodiments, wherein the structural elements (10) each extend along the transport direction (5) as well as proportionally over the cross-section of the waveguide (1), such that in the cross-section of the waveguide (1) a plurality of cross-sectional regions (20) is defined, each corresponding to the cross-section of a single structural element (10), wherein the structural elements (10), in particular their cross-sectional regions (20), are formed unevenly but uniquely defined by a predetermined rule.

A twenty second embodiment of the invention relates to a waveguide according to any one of the preceding embodiments, wherein the structural elements, in particular their cross-sectional regions, have a non-uniform, in particular aperiodic, predetermined arrangement which is unambiguously defined by a predetermined rule, and/or wherein the structural elements, in particular their cross-sectional regions, have non-uniform, in particular divergent, geometries, for example non-uniform diameters, which are unambiguously determined by a predetermined rule, and/or wherein the structural elements have non-uniform, in particular mutually differing, refractive indices which are unambiguously determined by a predetermined rule.

A twenty third embodiment of the invention relates to a waveguide according to any one of the preceding embodiments, wherein the structural elements, in particular their cross-sectional regions, are formed unevenly in such a way that electromagnetic waves transmitted by the waveguide remain localized in a direction transverse to the transport direction, in particular in order to transmit image information.

A twenty fourth embodiment of the invention relates to a waveguide according to any one of the preceding embodiments, wherein the proximal end is twisted relative to the distal end.

A twenty fifth embodiment of the invention relates to a waveguide according to any one of the preceding embodiments, wherein each fiber has a diameter, a core and optionally a cladding, and at least one of the fiber diameter and diameter ratio of core-to-cladding varies as function of a fiber's radial displacement from the central bundle axis.

A twenty sixth embodiment of the invention relates to a use of a waveguide (1) according to any one of the preceding embodiments, wherein the waveguide (1) is a rigid image guide or an at least partially flexible image guide used as a component in a medical device for an endoscope or as an x-ray imaging faceplate, as an image modifying optical component or as a fiber optical component such as a (resizing) taper or an image inverter for example used in a night vision device, as a component for spatial multiplexing for data communication, as a component in remote optical sensing, as a component in a lighting application, and as an energy relay for a light field energy system.

A twenty seventh embodiment of the invention relates to a combination of one or more of the preceding embodiments.

### EXAMPLES

The following waveguides were prepared and analyzed.

### Example 1

An 18 mm thick glass optical fiber bundle where the majority of light is transmitted via Anderson localization (Glass Anderson Localization Optical Fiber bundle, GALOF, or Transverse Anderson Localization Optical Fiber bundle, TALOF) instead of traditional total internal reflection was prepared as follows. Two types of glass rods (monos) with the same diameter, but a refractive index difference of 0.33 were arranged in a ˜50:50 mixture in a hexagonal multi configuration by a predetermined fashion, as disclosed herein, and drawn to a fiber bundle. In a second drawing step a plurality of these multi fibers is assembled in multi-multi arrangement, where the multi fibers were randomly oriented. Additional drawing steps in the same manner were applied, until

the diameter of the mono fiber was reduced to a size of 700-800 nm to produce the GALOF.

The slanted sharp edge of a black and white image was used to determine the MTF as described herein for a blank target, a fiber optical plate (FOP) product number 24A from SCHOTT North America, as well as the GALOF. The results are shown in FIG. 25.

As shown in FIG. 25, the GALOF image guide did not reach the resolution limit of the optical detection system (blank), but the GALOF outperformed the FOP, although imaged with a lower magnification. In addition, the MTF of the FOP showed artifacts (peaks/singularities) which stem from the visible periodic structure of the waveguide, causing high contributions in the corresponding Fourier components.

### Example 2

The slanted sharp edge of a black and white image was viewed through the GALOF from Example 1 at 200×, 300×, 500×, 1000× and 1500× magnification. The MTF for the blank and GALOF was determined as described herein. The results are shown in FIG. 26.

As shown in FIG. 26, the extension of the resolvable spatial frequency range with increasing magnification is eminent for the blank images, caused by the effective pixel size related Nyquist limit. Only at the highest resolutions a saturation of the blank images, due to the limiting performance of the imaging system is visible. A similar behavior is observed for the TALOF MTFs, also the saturation (which happens around a magnification of 500×) in this case is limited by the optical transmission performance of the waveguide. The images below the graph show the TALOF transmitted slanted edge pictures, used for the analysis.

### Example 3

An image of the negative USAF51 target described herein was viewed through the GALOF from Example 1 at 300×, 500× and 1,000× magnification. The MS-SSIM was determined as described herein. The results are shown in FIG. 27.

### Example 4

An image of the positive USAF51 target described herein was viewed through the GALOF from Example 1 at 300×, 500× and 1,000× magnification. The MS-SSIM was determined as described herein. The results are shown in FIG. 28.

### Example 5

An image of the negative USAF51 target described herein was viewed through 10 mm and 20 mm samples of the GALOF from Example 1 at 1,000 magnification. The MS-SSIM was determined as described herein and the value was compared to an image taken under the same conditions using the SCHOTT FOP product RFG 88 having a 3 μm fiber diameter. The results are shown in FIG. 29A. FIG. 29B shows images and the MS-SSIM from another measurement of 10 mm, 20 mm, 50 mm and 100 mm samples of the GALOF from Example 1 at 1,000 magnification. FIG. 29C is a plot of the data from FIGS. 29A and 29B.

### Example 6

An image of the negative USAF51 target described herein was viewed through a 5 cm sample of the GALOF from Example 1 at 1,000 magnification. The MS-SSIM was determined as described herein. The results are shown in FIG. 30.

### Example 7

An image of the negative USAF51 target described herein was viewed through the GALOF from Example 1 at 1,000× magnification. The MS-SSIM was determined as described herein. The results are shown in FIG. 31.

### Example 8

A homogeneously illuminated image of the Group 1 square of a negative USAF51 target was viewed through the GALOF from Example 1 at 200× magnification and compared to the blank image and a fiber bundle (middle—manufactured by Honsun with 6 μm fiber diameter). The discrete Fourier transformations were determined as described herein compared. The results are shown in FIG. 33.

The upper row in FIG. 33 shows homogeneously backside illuminated (lambertian) areas without (left—blank) and with image guide transmission (middle—5 mm thick FOP with 6 μm fiber diameter, hexagonal packaging; right—GALOF). The middle row shows the discrete Fourier transformations (FFT) of the corresponding images, with a typical high DC peak in the middle. For the FOP we see pronounced off center peaks which reflect the six-fold symmetry of the fiber arrangement. The TALOF FFT shows elevation at some frequencies, but no distinct peaks. The

lower row shows integrated line scans (along a symmetry axis from top to bottom). The blank and TALOF curves can be described as monotonically decreasing functions (ignoring noise).

The FOP curve shows a pronounced narrow peak structure: Symmetric to the center position with an amplitudes significantly larger than noise level (25% of the central peak), which creates local maxima.

### Example 9

A glass optical fiber bundle was prepared in the same manner as Example 1, expect that the thickness was 10 mm.

An image of the negative USAF51 target described herein was viewed through the GALOF. The Fourier coefficients and the relative contrast P were determined for the GALOF and the SCHOTT 3 μm FOP product RFG 88 as described herein. The results are shown in FIG. 33.

FIG. 33 shows the values of the Fourier coefficients for a blank image and the sample images (top), and the ratio between the corresponding values (FOP and GALOF) and the reference (blank) resulting in the relative contrast P.

### Example 10

An image of all elements of Group 7 of a positive USAF51 target described herein was viewed through a GALOF at 300× magnification. The MS-SSIM was determined for a 50 mm and 1,000 mm long sample, respectively, as described herein before. The results are shown in FIG. 32.

1. A waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein for an image of Groups 6 and 7 of a positive USAF51 target, the waveguide (1) has a MS-SSIM greater than 0.65 for a transmission length of up to 20 mm, a MS-SSTM greater than 0.60 for a transmission length of up to 50 mm, a MS-SSIM greater than 0.50 for a transmission length of up to 100 mm, and a MS-SSIM greater than 0.45 for a transmission length of up to 1,000 mm.

2. A waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a cut-off frequency (f_{cut}) greater than 170 lp/mm.

3. The waveguide (1) of claim 2, wherein the waveguide (1) has a cut-off frequency (f_{cut}) greater than 170 lp/mm and less than 1,000 lp/mm.

4. The waveguide (1) of claim 2, wherein the waveguide (1) has an area under the MTF calculated up to the cut-off frequency (f_{cut}) greater than 80 lp/mm.

5. The waveguide (1) of claim 4, wherein the waveguide (1) has an area under the MTF calculated up to the cut-off frequency (f_{cut}) greater than 80 and less than 500 lp/mm.

6. A waveguide (1) for transmitting electromagnetic waves, in particular for transmitting image information from a proximal end (2) of the waveguide to a distal end (4) of the waveguide, along a transport direction (5) extending between the proximal and distal ends, and over a cross-section extending transversely to the transport direction, wherein the waveguide (1) has a relative contrast P at 114 lp/mm greater than 0.40, a relative contrast P at 144 lp/mm greater than 0.20, and a relative contrast P from 114 to 287 lp/mm greater than 0.05.

7. The waveguide (1) of claim 6, wherein the waveguide (1) has a relative contrast P at 114 lp/mm greater than 0.40 and less than 0.90, a relative contrast P at 144 lp/mm greater than 0.20 and less than 0.70, and a relative contrast P from 114 to 287 lp/mm greater than 0.05 and less than 0.90.

8. The waveguide (1) of claim 6, wherein the waveguide (1) has a relative contrast P at 1,000 or less lp/mm greater than 0.05 and less than 0.70.

9. The waveguide (1) of claim 1, wherein the waveguide (1) has a Michelson contrast greater than 0.6.

10. The waveguide (1) of claim 9, wherein the Michelson contrast is greater than 0.6 and less than 1.0.

11. The waveguide (1) of claim 1, wherein the waveguide (1) has a plurality of structural elements (10), at least two different types of structural elements being comprised, namely a first type (10a) having a first refractive index and a second type (10b) having a second refractive index.

12. The waveguide (1) of claim 1, wherein the structural elements, in particular their cross-sectional regions, are formed unevenly in such a way that electromagnetic waves transmitted by the waveguide remain localized in a direction transverse to the transport direction, in particular in order to transmit image information.

13. The waveguide (1) of claim 1, wherein the waveguide (1) is a rigid image guide or an at least partially flexible image guide used as a component in a medical device for an endoscope or as an x-ray imaging faceplate, as an image modifying optical component or as a fiber optical component such as a (resizing) taper or an image inverter for example used in a night vision device, as a component for spatial multiplexing for data communication, as a component in remote optical sensing, as a component in a lighting application, and as an energy relay for a light field energy system.

14. The waveguide (1) of claim 2, wherein the waveguide (1) has a Michelson contrast greater than 0.6.

15. The waveguide (1) of claim 6, wherein the waveguide (1) has a Michelson contrast greater than 0.6.

16. The waveguide (1) of claim 2, wherein the waveguide (1) has a plurality of structural elements (10), at least two different types of structural elements being comprised, namely a first type (10a) having a first refractive index and a second type (10b) having a second refractive index.

17. The waveguide (1) of claim 6, wherein the waveguide (1) has a plurality of structural elements (10), at least two different types of structural elements being comprised, namely a first type (10a) having a first refractive index and a second type (10b) having a second refractive index.

18. The waveguide (1) of claim 2, wherein the waveguide (1) is a rigid image guide or an at least partially flexible image guide used as a component in a medical device for an endoscope or as an x-ray imaging faceplate, as an image modifying optical component or as a fiber optical component such as a (resizing) taper or an image inverter for example used in a night vision device, as a component for spatial multiplexing for data communication, as a component in remote optical sensing, as a component in a lighting application, and as an energy relay for a light field energy system.

19. The waveguide (1) of claim 6, wherein the waveguide (1) is a rigid image guide or an at least partially flexible image guide used as a component in a medical device for an endoscope or as an x-ray imaging faceplate, as an image modifying optical component or as a fiber optical component such as a (resizing) taper or an image inverter for example used in a night vision device, as a component for spatial multiplexing for data communication, as a component in remote optical sensing, as a component in a lighting application, and as an energy relay for a light field energy system.
